(19) United States
(12) Patent Application Publication
(10) Pub. No.: US 2025/0069592 A1
(43) Pub. Date: Feb. 27, 2025

(54) Method and System for Low-Complexity Real-Time Multiclass Hierarchical Audio Classification

(71) Applicant: Audio Technologies and Codecs, Inc., Chatham, NJ (US)

(72) Inventors: Deepen Sinha, Chatham, NJ (US); Mohd Aamir Khan, Bisrakh (IN)

(73) Assignee: Audio Technologies and Codecs, Inc., Chatham, NJ (US)

(21) Appl. No.: 18/417,724

(22) Filed: Jan. 19, 2024

Related U.S. Application Data
(60) Provisional application No. 63/578,657, filed on Aug. 24, 2023.

(51) Int. Cl. G10L 15/16; G10L 25/30

(52) U.S. Cl. CPC G10L 15/16; G10L 25/30

(57) ABSTRACT

The invention provides a method and a system for hierarchical audio classification. For getting high accuracy prediction with high resolution and low predictor complexity, the disclosed method uses a hierarchical classification approach with stateful prediction per frame aided by parallel AI transient detector for resetting the states of all stages at class transitions. To improve accuracy perfectly tagged database by innovative techniques of labeling are utilized. Further data augmentation is also done using signal processing techniques like audio mixing, blending of different type of data. The disclosed method applies short term audio normalization on database for normalized training and prediction of AI based Long Short-Term Memory (LSTM) networks. The disclosed method then uses a novel hierarchical classification approach with stateful LSTM prediction per frame aided by a parallel transient detector for resetting the states of all stages of hierarchical LSTM classifiers at class transitions.

### CROSS-REFERENCE TO RELATED APPLICATION

This application claims the benefit of U.S. Provisional Patent Application No. 63/578,657, filed Aug. 24, 2023, which is incorporated by reference herein in its entirety.

### FIELD OF THE INVENTION

The present invention relates generally to audio signal processing. More specifically, embodiments of the present invention relate to audio classification methods and systems.

### BACKGROUND OF THE INVENTION

Background description includes information that may be useful in understanding the present invention. It is not an admission that any of the information provided herein is prior art or relevant to the presently claimed invention, or that any publication specifically or implicitly referenced is prior art.

In many applications, there is a need to identify and classify audio signals. One such classification is automatically classifying an audio signal into speech, vocal music, non-vocal music, or background-noise/silence. In general, audio classification involves extracting audio features from an audio signal and classifying with a trained classifier based on the audio features.

Methods of audio classification have been proposed to automatically estimate the type of input audio signals so that manual labeling of audio signals can be avoided. This can be used for efficient categorization and browsing for a large amount of multimedia data. Audio classification is also widely used to support other audio signal processing components. For example, a speech-to-noise audio classifier is of great benefit for a noise suppression system used in a voice communication system. As another example, in a wireless communications system apparatus, through audio classification, audio signal processing can implement different encoding and decoding algorithms to the signal depending on whether or not the signal is speech, vocal music, non-vocal music, or silence. Yet another example is multi-band audio processing and enhancement systems such as Perceptual SoundMax™, wherein numerous processing parameters are best adjusted based on type of audio signals. In many of these applications it is desirable to combine the twin requirements of “high decision time resolution” and “high accuracy.”

One of the most widely used methods in the audio domain is audio classification. The application of machine learning, particularly deep learning, in audio classification has recently emerged. It can be used for the classification of genres, automatic speech recognition, virtual assistants, and other things. The model is trained using labeled audio datasets during the deep learning application process. The label of the audio helps the model map it. The label of the previously unseen audio is then predicted by the models.

U.S. Ser. No. 10/566,009B1 provides methods, systems, and apparatus, including computer programs encoded on a computer storage medium, for audio classifiers. In one aspect, a method includes obtaining a plurality of video frames from a plurality of videos, wherein each of the plurality of video frames is associated with one or more image labels of a plurality of image labels determined based on image recognition; obtaining a plurality of audio segments corresponding to the plurality of video frames, wherein each audio segment has a specified duration relative to the corresponding video frame; and generating an audio classifier trained using the plurality of audio segment and the associated image labels as input, wherein the audio classifier is trained such that the one or more groups of audio segments are determined to be associated with respective one or more audio labels.

U.S. Pat. No. 8,892,231B2 provides an audio classification system that includes at least one device which executes a process of audio classification on an audio signal. The at least one device can operate in at least two modes requiring different resources. The audio classification system also includes a complexity controller which determines a combination and instructs the at least one device to operate according to the combination. For each of the at least one device, the combination specifies one of the modes of the device, and the resources requirement of the combination does not exceed the maximum available resources. By controlling the modes, the audio classification system has improved scalability to an execution environment.

EP2272062B provides a method for classifying an audio signal. The method comprises estimating at least one generalized Gaussian distribution shaping parameter value for a plurality of samples of the audio signal; generating at least one audio signal classification value by mapping the at least one estimated generalized Gaussian distribution shaping parameter value to one of at least two probability values associated with each of at least two quantization levels of the estimated shaping parameter; comparing the at least one audio signal classification value to at least one previous audio signal classification value, and generating the at least one audio signal classification decision dependent at least in part on the result of the comparison.

CN105074822B provides a device and a method for audio classification and audio processing. In one implementation mode, the audio processing device comprises an audio classifier for classifying audio signals to at least one audio type in real-time, an audio-improving device for improving the experience of audiences, and an adjusting unit for adjusting at least one parameter of the audio improving device based on a confidence value of at least one audio type in a continuous mode.

JP6921907B2 provides a device and a method for audio classification and processing. In some embodiments of this document, an audio processing device includes an audio classifier that classifies audio signals into at least one audio type in real time; an audio improvement device for improving the experience of an audience; and an adjustment unit that adjusts at least one parameter of the audio improvement device in a continuous manner based on the confidence value of the at least one audio type.

One of the most widely used methods in the field of music information retrieval is the use of a classifier in the audio domain. The audio classification is further broken down into four sub-classification stages, which are as follows:
1. Music classification (Genre, Moods, Vocals etc.)
2. Acoustic data/event classification
3. Environmental sound classification (Noise classification)
4. Natural language utterance classification (speech and language recognition, text to speech etc.)

In the past, rule based classifiers, and simpler non-deep neural network classifiers based on models such as Logistic Regression (LR), and Gaussian Mixture Model (GMM) have been in audio classification. More recently large deep neural networks, in particular, are becoming increasingly popular in machine learning as a result of the rise of high-complexity hardware and technology like the GPU and FPGA. Large neural networks like Convolutional Neural Network (CNN), Recurrent Neural Network (RNN), and Long Short-Term Memory (LSTM) are capable of producing breakthrough results in the audio, image, and video fields; for detailed description of various Neural Network architectures, see [Charu C. Aggarwal, “Neural Networks and Deep Learning,” A Textbook, Springer ISBN 978-3-319-94462-3]. The types of audio classes, neural networks such as CNN and LSTM, and some audio classification techniques each with their limitations are discussed in the present disclosure in the below headings.

Different techniques were used earlier for classifying audio, but they have their limitations. Some of them are discussed as follows
1. Rule-based method. Frame features are calculated and using thresholding on features value, rule-based decision is carried out for deciding the audio class category. This method is simple but has poor accuracy.
2. GMM based. Instead of rule-based GMM probability is computed for each class. GMM mean/mu vectors and sigma matrices are derived using the Expectation-Maximization algorithm on training data. It is better than rule-based but still has low accuracy.
3. Logistic regression. Logistic regression algorithm is unable to train on large data and always suffers the problem of model underfit. Accuracy also is low with this method.
4. CNN-based multi-class classification. CNN with audio spectrum images as input is a popular method. But it is well known that CNN is useful for image analysis and classification. Sometimes, it is unable to distinguish between audio spectrum images and fails to predict properly. Therefore, these methods also suffer low accuracy for the targeted applications.
5. LSTM-based multi-class classification. LSTM is the most popular network used in audio classification. It naturally captures the time dependent nature of feature evolution in audio. It needs proper class-discriminating audio features as input. If class-discriminating features are not provided to LSTM network, prediction accuracy could be unsatisfactory. Even assuming suitable audio features have been fed into a LSTM classifier, another big challenge with LSTM is that it needs large audio slice (64 frames or 1.5 sec data) as input for achieving good accuracy. But using a bigger audio slice leads to poor decision time resolution and makes it impossible to predict a perfect class transition. Class prediction is received after high delay.

In a typical LSTM based classifier 64 or more audio frames are used by LSTM to achieve high accuracy as an input (of the audio slice). Prediction accuracy can be improved with a larger slice size, but decision time resolution suffers as a result. The LSTM model architecture and training are constrained in ways that conflict with requirements for “high decision time resolution” and “high accuracy.” Another Major challenge in AI based audio classifier with hierarchical classification is excessive complexity involved in audio class prediction. It is essential that real-time AI prediction should be low complexity for handheld embedded devices as power constraint is there.

Although, an algorithm with 3 stages AI hierarchical audio classifier with high accuracy and high-resolution decisions has recently been developed [as described in an associated patent application “A method and a system for real-time multiclass hierarchical audio classification” by inventors Sinha, Khan, and Kapoor] further complexity reduction of the predictor is highly desirable especially for low end handheld devices and receivers.

LSTM based audio prediction works best with using past LSTM states (for example 64 past time-steps states), But LSTM based prediction must be done at smaller time intervals to achieve desired decision-time-interval, however, this leads to complexity increase in the predictor. At every prediction step, past states are calculated independent to last prediction step which is not desirable for low complexity system design.

In view of the foregoing, there is a need for an improved method and system for hierarchical audio classification that is able to overcome the above limitations and provides high accuracy prediction as well as high time resolution decisions with minimal delay and at the same time ensure low complexity.

The present application provides these and other advantages as will be apparent from the following detailed description and accompanying figures.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Similarly, issues identified with respect to one or more approaches should not assume to have been recognized in any prior art on the basis of this section, unless otherwise indicated.

### SUMMARY OF THE INVENTION

This summary is provided to introduce a selection of concepts in a simplified format that are further described in the detailed description of the present disclosure. This summary is not intended to identify key or essential inventive concepts of the present disclosure, nor is it intended for determining the scope of the present disclosure.

It is an object of the invention to provide an improved method and system for hierarchical audio classification which provides high accuracy prediction as well as high time resolution decisions with minimal delay and low complexity.

According to an embodiment (“illustrative embodiment”), the disclosure provides a method and system for hierarchical audio classification. For getting high-accuracy prediction with high resolution, the disclosed method uses a perfectly tagged database by innovative techniques of labeling. Further data augmentation is also done using signal processing techniques like audio mixing, and blending of different types of data. The disclosed method applies short-term audio normalization on database for normalized training and prediction of AI-based Long Short-Term Memory (LSTM) networks as only short-term audio normalization is applicable in real-time and a global loudness normalization is not possible. The method further develops high-quality audio features per frame (1024 RAW PCM samples) based on audio signal processing and deep analysis using large, tagged data. These frame features represent a time sequence series which is provided as input to a neural network for audio classification. Further, the disclosed method uses a hierarchical classification approach. Hence, instead of classifying audio using a single LSTM network with multiple class output (four classes), three different LSTM networks with binary classification output are used in different stages with hierarchy.

In the illustrative embodiment of the invention, in the 1st stage, the first LSTM model classifies between “NOISE” and “AUDIO”. If “AUDIO” is predicted, then the second LSTM model classifies between “SPEECH” and “MUSIC”. If “MUSIC” is predicted, then the third LSTM model classifies between “NON-VOCAL” and “VOCAL”. It is observed that a hierarchical binary classification network has high accuracy as compared to a single multi-class classifier.

In the illustrative embodiment of the invention, for getting high accuracy, each of the hierarchical multi-stage LSTM classifier uses a slice of 64 audio frames as an input. To obtain higher time-resolution decisions, the classification decisions are output at an interval significantly faster than the 64-frame slice length, e.g., once every 16 frames or even faster. Additionally, the disclosed method, uses a 4^{th} LSTM based classifier in the form of a parallel transition detection LSTM network. Using this parallel transition detector to reset the states of 3 LSTM classifiers used in the hierarchical classifier, in a manner disclosed herein, the method is able to achieve higher time resolution decisions while at the same time achieving high decision accuracy.

The challenges in high accuracy audio class detection in a real-time system are overcome in the present invention by the use of an additional AI technique in the form of a separate transition detector. By using hierarchical-structured AI binary classifications and using an AI class transition detector, high accuracy as well as high-resolution decision is reached. Instead of using a non-binary single classifier with a single AI model, 3 stages hierarchical binary classifier with 3 separate AI models is used for better accuracy and results. The overall training accuracy of the 3-stage classifier is 97.87% and the testing accuracy is 96.23% on a comprehensive high quality large size database. Furthermore, that the use of the fourth-class transition detector running in parallel to all 3 main binary classifiers, improves the class decisions at class transition boundaries. Transient detector gives a training accuracy of 94.91% and a testing accuracy of 94.55% on a large class transition database. Feature engineering innovations and analysis play an important role in achieving high-accuracy goals. For example, high-quality features having high discrimination potential are used in the classification which leads to good results. Most importantly, the LSTM neural network design and selection of best hyper-parameters at each stage by doing extensive training experiments plays a crucial role in creating a good hierarchical classifier.

In the illustrative embodiment of the invention, the goal of low complexity prediction is achieved using stateful LSTM prediction with state reset at audio signal class transitions. The state of art LSTM training algorithms work substantially better if trained with stateless (as opposed to stateful) data slices, these typically then provide significantly reduced prediction accuracy if the LSTM predictor is run in a stateful fashion. The present invention teaches that any such loss in prediction accuracy can be avoided by the use of a highly accurate transient detector network which identifies the LSTM network state reset locations. With such state reset mechanism, the prediction accuracy is higher and virtually identical to the accuracy with stateless prediction at the end of a slice. Another advantage of stateful operation is the decision based on full slice are available at each time step, therefore decision time resolution may be as high as per audio frame without incurring any penalty in terms of increased complexity or reduced accuracy. This architecture, therefore, leads to real-time high time resolution audio class estimation at every time-step with high accuracy and lower power consumption requirement. The predictor, can be implemented on low power embedded platforms such as handheld audio receivers, field communication devices, wireless earphones, set-top boxes, audio power optimized chips, and audio systems based on battery.

To further clarify the advantages and features of the present disclosure, a more particular description of the disclosure will be rendered by reference to specific illustrative embodiments thereof, which is illustrated in the appended drawings. It is appreciated that these drawings depict only typical embodiments of the disclosure and are therefore not to be considered limiting of its scope. The disclosure will be described and explained with additional specificity and detail with the accompanying drawings.

### BRIEF DESCRIPTION OF THE DRAWINGS

The subject matter that is regarded as the invention is particularly pointed out and distinctly claimed in the claims at the conclusion of the specification. The foregoing and other aspects, features, and advantages of the invention are apparent from the following detailed description taken in conjunction with the accompanying drawings in which:

FIG. 1 illustrates a block diagram for detailed architecture for real-time hierarchical audio classifier with stateless LSTM prediction, in accordance with an embodiment of the present disclosure.

FIG. 2 illustrates a block diagram for modified real-time hierarchical audio classifier with stateful LSTM prediction, in accordance with an embodiment of the present disclosure.

FIG. 4 illustrates architecture of LSTM cell with description of the cell elements, in accordance with an embodiment of the present disclosure.

FIG. 5A illustrates stateless LSTM prediction using slices, in accordance with an embodiment of the present disclosure.

FIG. 5B illustrates stateful LSTM prediction using slices, in accordance with an embodiment of the present disclosure.

FIG. 6 and FIG. 7 illustrate a graph for blending audio signals showing the plots, in accordance with an embodiment of the present disclosure.

FIG. 8 depicts a method for blending audio signals, in accordance with an embodiment of the present disclosure.

Further, skilled artisans will appreciate that elements in the drawings are illustrated for simplicity and may not have necessarily been drawn to scale. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having benefit of the description herein.

### DETAILED DESCRIPTION OF THE INVENTION

For the purpose of promoting an understanding of the principles of the invention, reference will now be made to the embodiment illustrated in the drawings and the description below, i.e., an “illustrative embodiment”, and specific language will be used to describe the same. It will nevertheless be understood that no limitation of the scope of the invention is thereby intended. Such alterations and further modifications in the illustrated system, and such further applications of the principles of the invention as illustrated therein would be contemplated as would normally occur to one skilled in the art to which the invention relates. Unless otherwise defined, all technical and scientific terms used herein have the same meaning as commonly understood by one of ordinary skilled in the art. The system, methods, and examples provided herein are illustrative only and are not intended to be limiting.

In the description below, the term “illustrative embodiment” may be used singularly—i.e., the illustrative embodiment; or it may be used plurally—i.e., illustrative embodiments and neither is intended to be limiting. Moreover, the term “illustrative” as used herein is to be understood as “none or one or more than one or all.” Accordingly, the terms “none,” “one,” “more than one,” “more than one, but not all” or “all” would all fall under the definition of “illustrative.” The term “illustrative embodiments” may refer to one embodiment or to several embodiments or to all embodiments, without departing from the scope of the present disclosure.

The terminology and structure employed herein is for describing, teaching, and illuminating illustrative embodiments and their specific features. It does not in any way limit, restrict or reduce the spirit and scope of the claims or their equivalents.

More specifically, any terms used herein such as but not limited to “includes,” “comprises,” “has,” “consists,” and grammatical variants thereof do not specify an exact limitation or restriction and certainly do not exclude the possible addition of one or more features or elements, unless otherwise stated, and furthermore must not be taken to exclude the possible removal of one or more of the listed features and elements, unless otherwise stated with the limiting language “must comprise” or “needs to include.”

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments.

Any particular and all details set forth herein are used in the context of illustrative embodiments and any additional embodiments, and therefore should not be necessarily taken as limiting factors to the attached claims. The attached claims and their legal equivalents can be realized in the context of embodiments other than the ones used as illustrative examples in the description below.

Although the illustrative embodiments of the present invention will be described in the following description in relation to an audio signal, one should keep in mind that concepts taught in the present invention equally apply to other types of signals, in particular but not exclusively to various type of speech and non-speech sound signals.

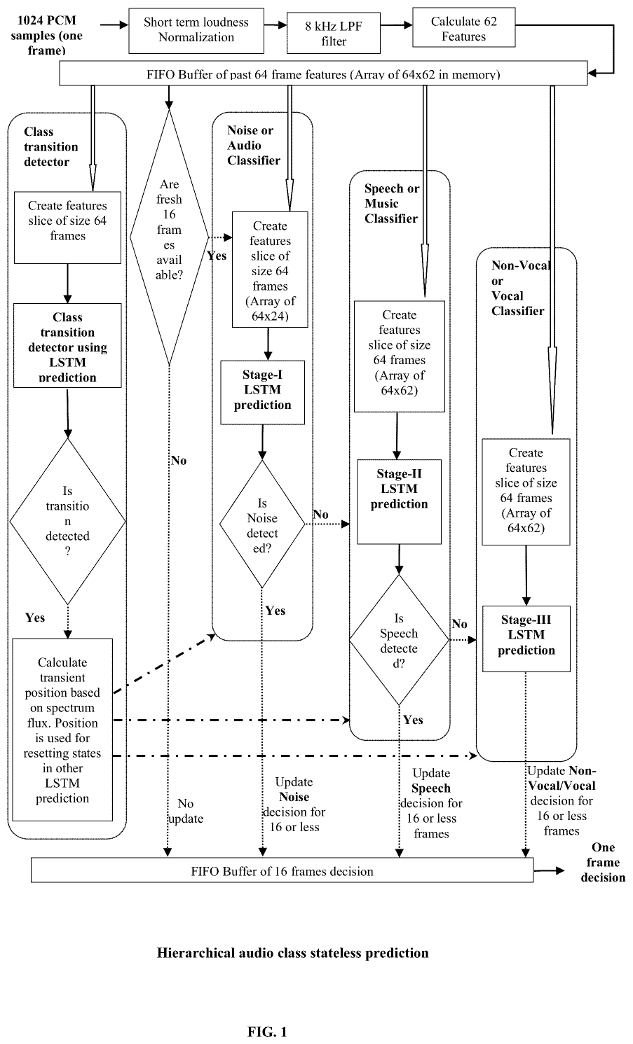

The present invention provides an improved method and system for hierarchical audio classification which provides high-accuracy low complexity prediction as well as high-time resolution decisions with minimal delay. The method for hierarchical audio classification of the present invention comprise training and generating at least two independent Long Short-Term Memory (LSTM) networks by a large tagged database of audio which are utilized in at least two (2) stages of the hierarchical classifier. In the illustrative embodiment of the present invention, the said hierarchical classifier consists of three (3) stages as shown in FIG. 1, whereby three audio classifiers comprise of a noise/audio classifier, a speech/music classifier and a vocal-music/non-vocal-music classifier are utilized; each of the hierarchical multi-stage LSTM classifier uses a slice of 64 audio frames as an input. Furthermore, a separate class transition detector LSTM network based on a tagged database class transitions is trained. To achieve higher model accuracy and flexibility in training, it is assumed, during training, that the LSTM operates in a stateless fashion for each slice of 64 frames; short-term audio level/loudness normalization is applied on the large tagged database and the class transition tagged database during training. Class predictor consists of sequentially inputting audio frame data, into the LSTM neural networks with a slice of 64 audio frame which is operating in a stateful mode; classifying, in a first stage, between an intelligible audio class or the noise class, in an incoming audio signal; classifying, in a second stage, between the speech class or the music class, in the incoming audio signal, upon detecting the intelligible audio in the first stage; classifying, in a third stage, between a vocal music class and a non-vocal music class, in the incoming audio signal, upon detecting the music in the second stage; determining position of the audio class transition by running a class transient detection using a parallel LSTM transient detector network in parallel to each of the first stage, the second stage, and the third stage of the hierarchical audio classification; providing feedback from transition detector to the 3 stages of hierarchical detectors in real-time for improved accuracy, and performing a final classification of the incoming audio signal based on the predicted audio class and the determined position of the audio class transition, at a time resolution much higher than the slice duration.

The disclosed method and system of the present invention provides real-time high accuracy as well as high-time resolution prediction of audio signal as “NOISE”, “SPEECH”, “VOCAL MUSIC” and “NON-VOCAL MUSIC”. Audio classification in the above 4 categories has a lot of scope in numerous applications such as multi-band loudness-controlled processing, Vocal/singing/dialogues/speech enhancement, music enhancement, stereo image enhancement & audio spatialization, auto profile set in receivers based on signal detected (TV, smartphones, Tablets), adaptive noise-cancellation (ANC), cross-fading application, aid in vocal removal filters, adaptive compression codec mode switching in transmission, and improving compression algorithms and much more.

Most of the time, noise is considered to be an undesirable sound because it lacks meaningful information; applications for noise cancellation and cleaning are used to remove or discard noise. Noise may include sounds like chirping, humming, and environmental noise. Further, speech is the type of audio which consists of human speech that conveys important cognizable information. Human speech typically has a bandwidth of up to 8 kHz. Furthermore, vocal music is the part of the music which contains human singing along with background music, and the non-vocal music includes the sound of instruments either single or multiple being played simultaneously.

In the illustrative embodiment of the invention, the method comprises of running the 3 LSTM predictors in the hierarchical structure, in a stateful fashion, whereby states of the predictors are not reset at the beginning of each slice, and resetting, by the class transition detector, stateful LSTM states at the time of the audio class transitions. At explained in later sections below, this has the dual advantage of reduced complexity and improving decision time resolution further to the extent that audio classifications decisions are accurate even when outputted at every audio frame interval (i.e., at 64 times the frequency of the slice length).

In an illustrative embodiment of the present invention, the disclosed classification algorithm is targeted for real-time audio applications such as intelligent adaptive processing in next-generation of audio dynamics processors [G. W. McNally, “Dynamic Range Control of Digital Audio Signals,” J. Audio Eng. Soc., vol. 32, pp. 316-327 (1984 May)], Intelligent codec mode adaptation in audio compression codecs such as High-Efficiency Advanced Audio Coder (HE-AAC) [ISO/IEC 14496-3:2005 Information technology—Coding of audio-visual objects—Part 3: Audio] and Perceptual Audio Coder (PAC) [V. Madisetti, D. B. Williams, eds., The Digital Signal Processing Handbook, Chapter 42, D. Sinha et al., “The Perceptual Audio Coder (PAC),” CRC Press, Boca Raton, Fl., 1998.], intake/outtake tagging for Cross-Fades, and stereo enhancement & audio spatialization applications. Many other such applications are possible.

Hierarchical Audio Class Prediction with Stateful Operation

In the illustrative embodiment of the invention, the method uses a three-stage hierarchical binary classifier with three independent Long Short-Term Memory (LSTM) networks.

In the illustrative embodiment an additional parallel transition detector has a crucial role in improving the decision resolution and reducing complexity in a real-time audio classification system. Although, decisions can be improved using multiple passes on stored audio, but in real-time it is not possible to do a second analysis. Further, the challenge in real-time system is that due to delay constraint less amount of future audio is accessible for deciding the audio class which makes it hard to get an accurate and precise decision. However, the disclosed invention uses a transition detector in parallel to other classifiers in the real-time system for solving this major issue.

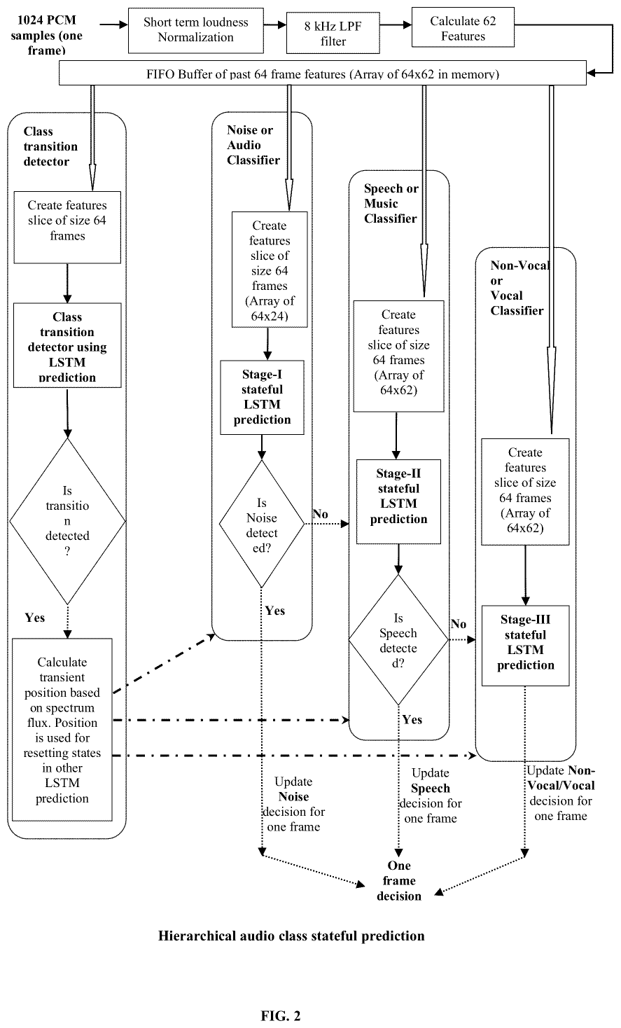

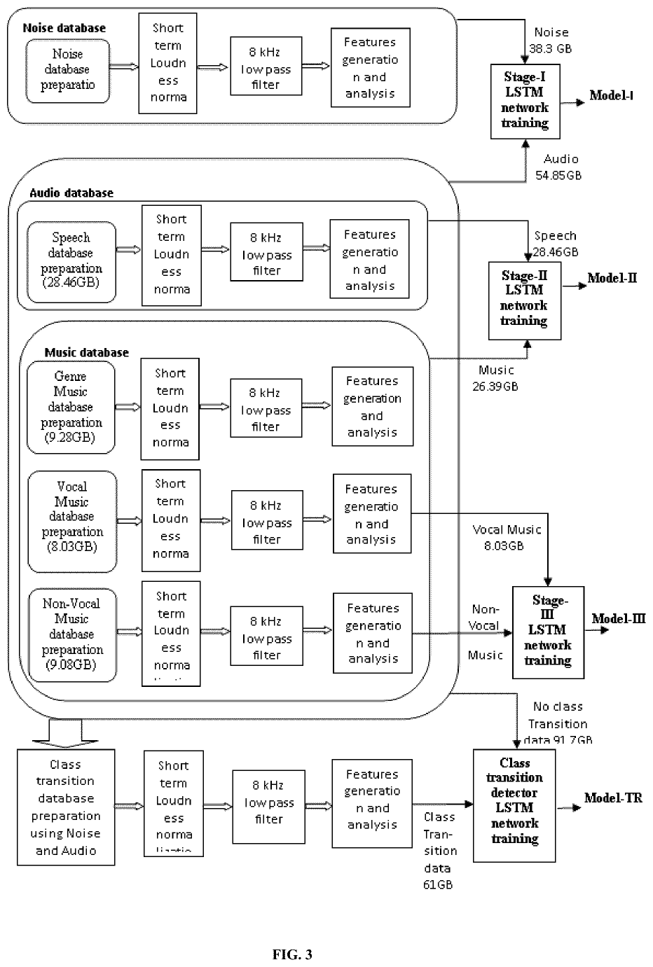

In using the hierarchical 3 stage classifier, two modes are possible as illustrated in FIG. 1 and FIG. 2 respectively; while the structure in FIG. 1 uses stateless prediction, whereby LSTM states are reset at the beginning of each slice, the structure in FIG. 2 uses stateful operation whereby states of LSTM predictor are maintained between slices. The illustrative embodiment of the present invention uses the structure in FIG. 2 which illustrates a block diagram for detailed architecture for audio class prediction in real-time in stateful mode with state resets at class transitions. The advantages of this audio classifier structure for real-time applications will become apparent in the description below. It provides classification decision at very high resolution up to a per frame decision, i.e., it takes one new audio frame (22 ms) as input, and detects signal type at once every frame; furthermore, the computational complexity is significantly lower.

As shown in FIG. 2, the first stage is based on acoustic event classification, in which, the classifier differentiates between an intelligible audio (Human speech/Music) or Noise (including silence). In case, the intelligible audio is detected, further classification is performed in 2nd stage. The 2nd stage classifies the incoming audio into speech or music. Further, in the event of music detection, it is passed to 3rd stage, where it is further classified into Vocal (Human singing) and non-vocal (instrumental music). To make precise transition detection between two different audio classes, a parallel transient detector, also based on a deep learning model, is used; the class transient detection runs in parallel, and it determines the accurate position of class transition. The main function of transient detection is to aid the multi-stage classifier and make it more robust in the event of quick transitions between two different classes. The final decision is taken based on the predicted class and detected position, as can be seen in the FIG. 2.

Classifier at each stage and transition detector is a deep learning model based on Long Short-Term Memory (LSTM). The choice of the LSTM model is based on the fact that the LSTM is able to learn the long and short-term dependencies, which has beneficial applications in audio domain. The classifier is trained with the frame features extracted from the incoming audio file. These frame features are chosen in such a way that they inculcate both temporal and frequency domain information, which has high discriminatory power between the audio classes.

These features are analyzed using the correlation matrix and various discrimination potentials and chosen thereafter, to train the LSTM model at each of the three stages and for the transition detection.

In the illustrative embodiment of the present invention, FIG. 3 illustrates a block diagram for all LSTM models training and generation. Three independent LSTM models are trained and generated using a large tagged database of Noise, Speech, Music (vocal and non-vocal music). One class transition LSTM model is trained using a class transition tagged database. Accordingly, block diagram for all LSTM models training and generation is shown in this figure.

The machine learning model design process has a crucial role in deciding the quality of classification. Results depend on many factors such as training database size and quality, audio processing on the database, type of audio features used as input, and most important model design and validation.

The long short-term memory or LSTM network used in the illustrative embodiment is a type of recurrent neural network (RNN), which not only learn short-term dependencies but also long-term dependencies between the current information and past information. LSTM are able to preserve the memory for a long time, through the internal gates of LSTM cells. These long- and short-term dependencies in the information, helps to learn the context. For e.g., the knowledge of past audio frame might be useful in the processing of the present audio frame. Gates control the flow of information. While training the LSTM model, the LSTM cells learn the incoming information as per the context. Through internal gates, LSTM can modify, remember, or forget the past information as per the requirement.

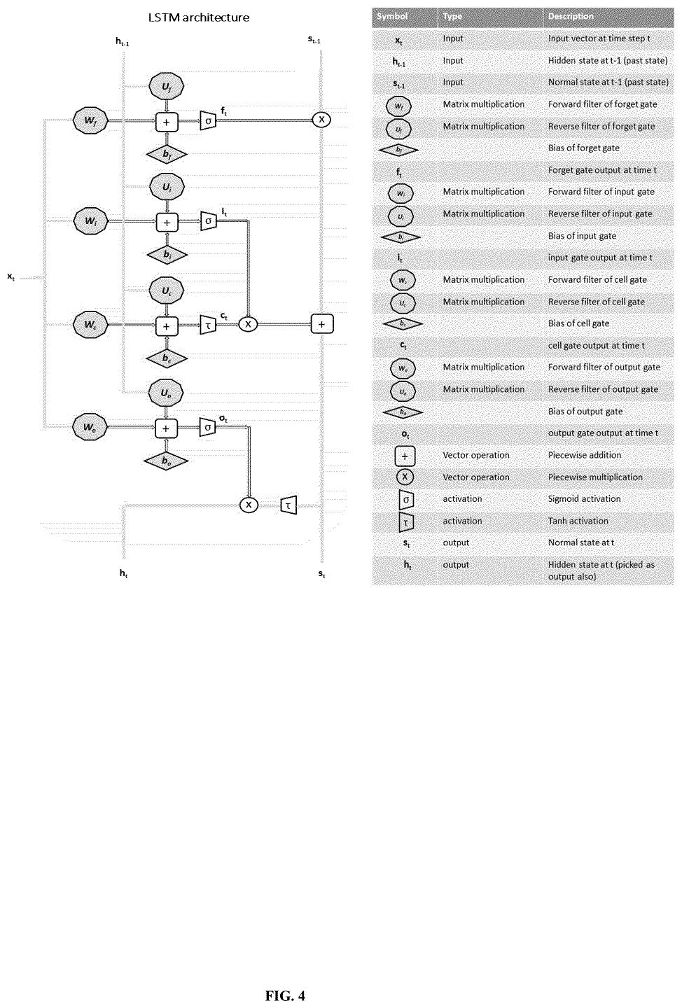

In the illustrative embodiment of the present invention, FIG. 4 illustrates architecture of LSTM cell with description of the cell elements. As shown in FIG. 4, in a LSTM cell, different operations are performed on the input data, the previous output, also known as the hidden state, and the previous cell state. The various main components of LSTM cell are:
a) Forget gate: For deciding whether to forget the information or to remember it.
b) Input gate: For updating the cell state, based on the pass hidden state and input.
c) Cell state gate: For giving the new cell state, based on the previous cell state and forget state.
d) Output gate: For deciding the next hidden state, based on the previous hidden state and input.

In the illustrative embodiment of the invention, training of LSTM network is performed using a stochastic gradient descent learning algorithm with back-propagation through time. Learning during training is done through stochastic gradient descent whereas; the gradient calculation is performed by back-propagation algorithm.

In the illustrative embodiment of the invention, in the training method, the input training data flows through the different network layers and calculates the predicted output. This is generally referred to as feed-forward propagation as the input data is fed in forwarding layers. Further, the method uses the error function, like binary cross entropy in our case, and the actual label, error is calculated on the predicted output. Using the gradient descent optimizer and back-propagation through time algorithm, the gradients, or derivatives of this error with respect to the weights and biases are calculated. Accordingly, the weights and biases are updated in the direction of minimization of error. The entire process is repeated as per the number of epochs given by the user.

In the illustrative embodiment of the invention, the equations used in back-propagation through time method in the case of LSTM model training are as follows:

Let the E be the error function, which in our case is binary cross entropy as described above. Hence, E is given by:

$$E = B C E = - \frac{1}{N} {\sum }_{i = 1}^{N} ( {y}_{i} * log log ( {p}_{i} ) + ( 1 - {y}_{i} ) * log log ( 1 - {p}_{i} ) )$$

The various LSTM cell equations are given in table below: <r>

| Gate | Equation |
|---|---|
| Forget | fₒₜ = (xₜ * W_{xf} + hₜ₋₁ * W_{hf} + b_{f}) |
| Gate | fₜ = σ(fₒₜ) |
| Input Gate | iₒₜ = (xₜ * Wₓᵢ + hₜ₋₁ * Wₕᵢ + bᵢ) |
| | iₜ = σ(iₒₜ) |
| | \tilde{c}ₒₜ = (xₜ * W_{xc} + hₜ₋₁ * W_{hc} + b_{c}) |
| | \tilde{c}ₜ = tanh(\tilde{c}ₒₜ) |
| Cell State | cₜ = fₜ · cₜ₋₁ + iₜ · \tilde{c}ₜ |
| Gate | |
| Output | Oₒₜ = (xₜ * Wₓₒ + hₜ₋₁ * Wₕₒ + bₒ) |
| Gate | Oₜ = σ(Oₒₜ) |
| | hₜ = Oₜ · tanh(cₜ) |

The various LSTM model internal parameters i.e., weights and biases, are given as: <r>

| Type of Gate | Weights | Biases |
|---|---|---|
| Input Gate | Wₓᵢ, Wₕᵢ, W_{xc}, W_{hc} | bi, b_{c} |
| Forget Gate | W_{xf}, W_{hf} | b_{f} |
| Output Gate | Wₓₒ, Wₕₒ | bₒ |

The various gate equations are described in Table-.

Using gradient descent, the derivatives of the error function E are obtained with respect to various weights and biases are as follows:
Gradient w.r.t Forget gate parameters:

$\frac{\partial E}{\partial {W}_{xf}} = Δ E * {O}_{t} * ( 1 - tanh tanh 2 {C}_{t} ) ⋆ {C}_{t - 1} ⋆ σ ( {f}_{ot} ) ⋆ ( 1 - σ ( {f}_{ot} ) ) ⋆ {x}_{t}$
$\frac{\partial E}{\partial {W}_{hf}} = Δ E * {O}_{t} * ( 1 - tanh tanh 2 {C}_{t} ) ⋆ {C}_{t - 1} ⋆ σ ( {f}_{ot} ) ⋆ ( 1 - σ ( {f}_{ot} ) ) ⋆ {h}_{t - 1}$
$\frac{\partial E}{\partial {b}_{f}} = Δ E * {O}_{t} * ( 1 - tanh tanh 2 {C}_{t} ) ⋆ {C}_{t - 1} ⋆ σ ( {f}_{ot} ) ⋆ ( 1 - σ ( {f}_{ot} ) )$

Gradient w.r.t Input gate parameters:

$\frac{\partial E}{\partial {W}_{xi}} = Δ E * {O}_{t} * ( 1 - tanh tanh 2 {C}_{t} ) ⋆ {\tilde{c}}_{t} ⋆ σ ( {i}_{ot} ) ⋆ ( 1 - σ ( {i}_{ot} ) ) ⋆ {x}_{t}$
$\frac{\partial E}{\partial {W}_{hi}} = Δ E * {O}_{t} * ( 1 - tanh tanh 2 {C}_{t} ) ⋆ {\tilde{c}}_{t} ⋆ σ ( {i}_{ot} ) ⋆ ( 1 - σ ( {i}_{ot} ) ) ⋆ {h}_{t - 1}$
$\frac{\partial E}{\partial {b}_{i}} = Δ E * {O}_{t} * ( 1 - tanh tanh 2 {C}_{t} ) ⋆ {\tilde{c}}_{t} ⋆ σ ( {i}_{ot} ) ⋆ ( 1 - σ ( {i}_{ot} ) )$
$\frac{\partial E}{\partial {W}_{xc}} = Δ E * {O}_{t} * ( 1 - tanh tanh 2 {C}_{t} ) ⋆ {i}_{t} ⋆ ( 1 - tanh tanh 2 {\tilde{c}}_{ot} ) * {x}_{t}$
$\frac{\partial E}{\partial {W}_{hc}} = Δ E * {O}_{t} * ( 1 - tanh tanh 2 {C}_{t} ) ⋆ {i}_{t} ⋆ ( 1 - tanh tanh 2 {\tilde{c}}_{ot} ) ⋆ {h}_{t - 1}$
$\frac{\partial E}{\partial {b}_{c}} = Δ E * {O}_{t} * ( 1 - tanh tanh 2 {C}_{t} ) ⋆ {i}_{t} ⋆ ( 1 - tanh tanh 2 {\tilde{c}}_{ot} )$

Gradient w.r.t Output gate parameters:

$\frac{\partial E}{\partial {W}_{xo}} = Δ E * tanh tanh {C}_{t} ⋆ σ ( {O}_{ot} ) ⋆ ( 1 - σ ( {O}_{ot} ) ) ⋆ {x}_{t}$
$\frac{\partial E}{\partial {W}_{ho}} = Δ E * tanh tanh {C}_{t} ⋆ σ ( {O}_{ot} ) ⋆ ( 1 - σ ( {O}_{ot} ) ) ⋆ {h}_{t - 1}$
$\frac{\partial E}{\partial {b}_{o}} = Δ E * tanh tanh {C}_{t} ⋆ σ ( {O}_{ot} ) ⋆ ( 1 - σ ( {O}_{ot} ) )$

Using the gradient descents of all weights, the weights are updated. Taking a as learning rate, the update equations are as follows:
Update w.r.t Forget gate parameters:

${W}_{xf} = {W}_{xf} - α \frac{\partial E}{\partial {W}_{xf}}$
${W}_{hf} = {W}_{hf} - α \frac{\partial E}{\partial {W}_{hf}}$
${b}_{f} = {b}_{f} - α \frac{\partial E}{\partial {b}_{f}}$

Update w.r.t Input gate parameters:

${W}_{x i} = {W}_{x i} - α \frac{\partial E}{\partial {W}_{x i}}$
${W}_{h i} = {W}_{h i} - α \frac{\partial E}{\partial {W}_{h i}}$
${b}_{i} = {b}_{i} - α \frac{\partial E}{\partial {b}_{i}}$
${W}_{x c} = {W}_{x c} - α \frac{\partial E}{\partial {W}_{x c}}$
${W}_{h c} = {W}_{h c} - α \frac{\partial E}{\partial {W}_{h c}}$
${b}_{c} = {b}_{c} - α \frac{\partial E}{\partial {b}_{c}}$

Update w.r.t Output gate parameters:

${W}_{x o} = {W}_{x o} - α \frac{\partial E}{\partial {W}_{x o}}$
${W}_{h o} = {W}_{h o} - α \frac{\partial E}{\partial {W}_{h o}}$
${b}_{o} = {b}_{o} - α \frac{\partial E}{\partial {b}_{o}}$

There are two modes of training (or updating weights) of LSTM network which are Stateless and Stateful. In stateless mode, LSTM states are reset for every slice/observation provided in training, hence, time positions of batches are not crucial in training the network, training data could be randomly provided to network for better convergence to optimum solution. Opposite to stateless, stateful mode training require data/batches in correct time order rather randomly due to which it fails to converge for cases when same audio signal is present for long durations. Therefore, stateful training mode of LSTM network is not feasible for audio signal classifier for all cases.

Similarly, during class prediction, LSTM network-based prediction can be stateless or stateful. Stateless prediction has fixed past states computation for final prediction (for example only last 64 time-steps states has impact on any current time-step prediction). In stateful prediction, states are never made zero, current time-step prediction is impacted with large hysteresis of audio. It could be concluded that, stateless prediction at each time-step requires fresh past states computation (in this case 64 time-step states) and stateful needs only last updated state which clearly indicates that stateful is more optimized in complexity as compare to stateless. Moreover, since states are not reset at the beginning of each slice, the predictor decision at each frame is based on the full past slice of 64 frames and has the full accuracy based on the slice length; therefore, predictor decisions are reliable at each audio frame, and thus have the highest possible time resolution of single audio frame.

In illustrative embodiment of the present invention, stateless network training is performed using slices consisting of 64 consecutive frames formed from the database of frame features, since stateful network training as stated above is not practical for audio classifiers. Not surprisingly, the best accuracy of these predictors is achieved when a full 64 consecutive frames of feature data has been fed into the predictor. However, while doing prediction to reduce complexity and achieve higher time resolution rather using stateless mode, stateful prediction mode is used but with the crucial additional step of state reset at class transitions (as signaled by the parallel transition detector). Without resetting the states at transitions, prediction error increases significantly at stateful prediction due to large hysteresis impact. Hence it is found that, by using stateful mode prediction with state reset at class transitions, as disclosed here, classifier maintains same accuracy as stateless operation, but with the advantages of lower complexity and high decision time resolution.

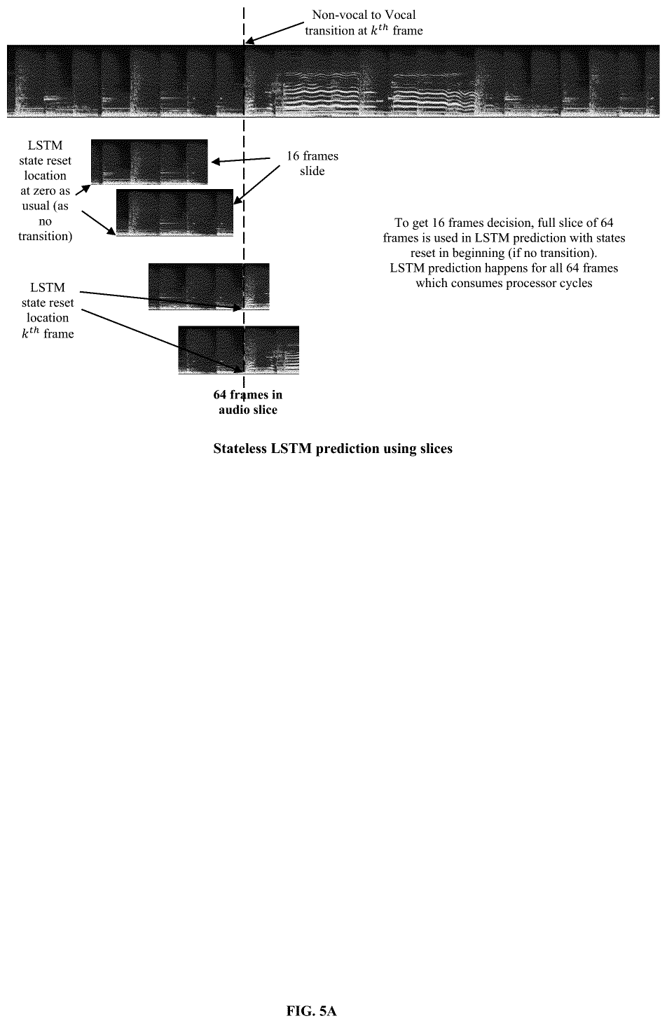

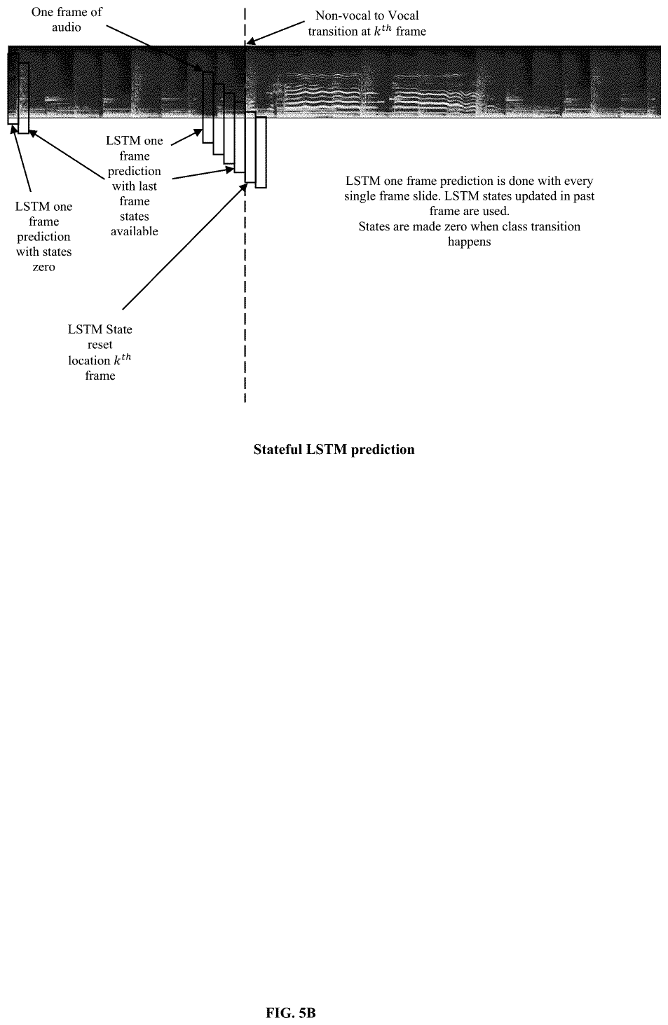

In illustrative embodiment of the present invention, FIG. 5A illustrates a block diagram for detailed architecture for real-time hierarchical audio classifier with stateless LSTM prediction. Similarly, FIG. 5B illustrates a block diagram for detailed architecture for real-time hierarchical audio classifier with stateful LSTM prediction.

LSTM prediction equations:

### First Layer . . . .

Input shape is B×D (64×23), B is number of frames in slice, D is number of features in a frame LSTM units H=64

$$h ( - 1 ) is zero$$

$$s ( - 1 ) is zero$$

$$LOOP t = 1 : B$$

$$f ( t ) \_Hx1 = SIGMA ( \text{} r\_filter \_f \_HxH * h ( t - 1 ) \_Hx1 + filter\_f \_HxD * x ( t ) \_Dx1 * + bias\_f \_Hx1 )$$

$$i ( t ) \_Hx1 = SIGMA ( \text{} r\_filter \_i \_HxH * h ( t - 1 ) \_Hx1 + filter\_i \_HxD * x ( t ) \_Dx1 * + bias\_i \_Hx1 )$$

$$c ( t ) \_Hx1 = tan h ( \text{} r\_filter \_c \_HxH * h ( t - 1 ) \_Hx1 + filter\_c \_HxD * x ( t ) \_Dx1 * + bias\_c \_Hx1 )$$

$$o ( t ) \_Hx1 = SIGMA ( \text{} r\_filter \_o \_HxH * h ( t - 1 ) \_Hx1 + filter\_o \_HxD * x ( t ) \_Dx1 * + bias\_o \_Hx1 )$$

$$s ( t ) \_Hx1 = f ( t ) \_Hx1 . * s ( t - 1 ) \_Hx1 + i ( t ) \_Hx1 . * c ( t ) \_Hx1$$

$$h ( t ) \_Hx1 = tan h ( s ( t ) \_Hx1 ) . * o ( t ) \_Hx1$$

where, x(t)_D×1 is input feature frame vector at time t.
h(t)_H×1 is passed to next layer and act as input in next LSTM layer

### Second Layer . . . .

Input shape is B×D (64×64), (B remains same as frames in slice but D is last layer LSTM units) LSTM units H=32

$$h ( - 1 ) is zero$$

$$s ( - 1 ) is zero$$

$$LOOP t = 1 : B$$

$$f ( t ) \_Hx1 = SIGMA ( \text{} r\_filter \_f \_HxH * h ( t - 1 ) \_Hx1 + filter\_f \_HxD * x ( t ) \_Dx1 * + bias\_f \_Hx1 )$$

$$i ( t ) \_Hx1 = SIGMA ( \text{} r\_filter \_i \_HxH * h ( t - 1 ) \_Hx1 + filter\_i \_HxD * x ( t ) \_Dx1 * + bias\_i \_Hx1 )$$

$$c ( t ) \_Hx1 = tan h ( \text{} r\_filter \_c \_HxH * h ( t - 1 ) \_Hx1 + filter\_c \_HxD * x ( t ) \_Dx1 * + bias\_c \_Hx1 )$$

$$o ( t ) \_Hx1 = SIGMA ( \text{} r\_filter \_o \_HxH * h ( t - 1 ) \_Hx1 + filter\_o \_HxD * x ( t ) \_Dx1 * + bias\_o \_Hx1 )$$

$$s ( t ) \_Hx1 = f ( t ) \_Hx1 . * s ( t - 1 ) \_Hx1 + i ( t ) \_Hx1 . * c ( t ) \_Hx1$$

$$h ( t ) \_Hx1 = tan h ( s ( t ) \_Hx1 ) . * o ( t ) \_Hx1$$

where, x(t)_D×1 is past layer h(t)_H×1 hidden state at time t.

### Third Layer . . . (Dense)

Input shape is B×D (64×32), (B remains same as old but D is last layer LSTM units)

Softmax output H=2

If return_sequences is true in last LSTM layer, then for every timestep, H output is generated

$$LOOP t = 1 : B$$

$$o ( t ) \_Hx1 = SOFTMAX ( filter\_HxD * x ( t ) \_Dx1 + bias\_Hx1 )$$

where, x(t)_D×1 is past layer h(t)_H×1 hidden state at time t.

If return_sequences is false in last LSTM layer, then only in last timestep, H output is generated

$$o ( B ) \_Hx1 = SOFTMAX ( filter\_HxD * x ( B ) \_Dx1 + bias\_Hx1 )$$

### LSTM Prediction Single Time Step Operations:

LSTM layer with H units and D input vector has complexity

$$Four HxH and Hx 1 matrix multiplication = 4 * H * ( H mul + H add ) = 8 * H * H$$

$$Four HxD and Dx 1 matrix multiplication = 4 * H * ( D mul + D add ) = 8 * H * D$$

$$Two Hx 1 matrix additions = 2 * ( H add )$$

$$Three Hx 1 dot product = 3 * ( H mul )$$

$$One Hx 1 addition = H add$$

$$Total operations = H * ( 8 H + 8 D + 6 )$$

MIPS Reduction with Stateful LSTM Operation:

As already discussed in the above paragraphs, operations required for single step LSTM layer prediction with H units and D input vector are H*(8H+8D+6)
First stage, first LSTM layer single step complexity=64*(8*64+8*24+6)=45440
First stage, second LSTM layer single step complexity=32*(8*32+8*64+6)=24768
Second stage, first LSTM layer single step complexity=64*(8*64+8*62+6)=64896
Second stage, second LSTM layer single step complexity=32*(8*32+8*64+6)=24768
Third stage, first LSTM layer single step complexity=64*(8*64+8*62+6)=64896
Third stage, second LSTM layer single step complexity=32*(8*32+8*64+6)=24768
Total operations per single step is =249536
   Let's say,
   N frames audio (multiples of 16 frames) are used for prediction
Stateless LSTM prediction complexity for N frames is, 249536*64*N/16
Stateless LSTM prediction complexity for 44100/1024 frames is, 249536*64*44100/1024/16
Stateless LSTM prediction complexity for one sec is, 249536*64*44100/1024/16=42.98 M
Stateless LSTM prediction MIPS are 42.98 (only assuming multiplication and addition)
stateful LSTM prediction complexity for N frames is, 249536*N
stateful LSTM prediction complexity for 44100/1024 frames is, 249536*44100/1024
stateful LSTM prediction complexity for one sec is, 249536*44100/1024=10.74 M
stateful LSTM prediction MIPS are 10.74 (only assuming multiplication and addition)
   There is 4 times reduction in MIPS, new architecture needs only 10 MHz as compare to 40 MHz processor for real time LSTM prediction.

In the illustrative embodiment of the invention, different type of machine learning models designing and training with various hyper-parameters is carried out. Finally, the best design and hyper-parameters are chosen for accurate results.

### Database Preparation:

In the preferred embodiment of the present invention, four types of databases are used for training and validation on models, i.e., noise database, speech database, music database, and non-vocal music and vocal music database.

### Noise Database:

In the preferred embodiment of the present invention, in database preparation for noise database, abundant noise samples are accumulated from different sources and used for Noise/Audio model training. Types of noise used are silence, hissing, crackled, static, radio, radar, electric, electronic, environmental, traffic, bus, train, car, park, office, home, café, food court, station, street, stage, crowd, events, firecrackers, equipment, appliances, synthetic noise, white noise, color noise (pink, brown), acoustic noise, etc. Further, for better training and avoiding over-fitting, Noise data is augmented by audio processing, low pass filtering, and mixing some noises.

Audio samples used as input in model generation/prediction are typically in 44100 Hz sample rate, 16 bit-depth, mono channel PCM WAVE format. Hence all the accumulated noise samples (could be any format or even compressed) are converted in 44100 Hz sample rate, 16 bit-depth, mono channel PCM WAVE audio for further processing and augmentation.

Band processing filters are applied for augmenting several Noise samples. Perceptual SoundMax™ audio processor DRC technology is used in processing some important noise samples for augmentation. Further, low pass filtering with cut-off 2.5 KHz and 4 KHz is done on many samples of high band noise and made part of training data. In practical situations, classification could be required on low band noise signals, hence low pass filtered noise data in training was necessary.

Some of the noises are mixed with each other to create a more diversified noise database. Mixing of the noise is done in a controlled way using dB analysis of input audio samples. Finally, 25.1 GB of Noise training data and 13.2 GB of Noise testing data are used.

### Speech Database:

In the illustrative embodiment of the present invention, in preparation of a speech database, speech data of all categories such as male, female, child, and old people is accumulated from different sources and are used in model training and generation.

It is well known that sometimes there are big duration silences (or background noise) present in speech samples, these types of speech samples are bad for Noise/Audio model training. Hence, it is crucial to remove these samples from the accumulated speech database.

Audio samples used as input in model generation/prediction are typically in 44100 Hz sample rate, 16 bit-depth, mono channel PCM WAVE format. Hence, all the accumulated speech samples (could be any format or even compressed) are converted in 44100 Hz sample rate, 16 bit-depth, mono-channel PCM WAVE audio for further processing and augmentation.

Clean speech samples without background noise are extracted. Generally, clean speech has silence pauses for some duration (small or large), hence based on the silence frame detector at some location in the speech sample, it could be declared that speech is clean or noisy.

Further, after separating clean speech, silence removal is used for converting a large duration of silence present in the speech to some small duration such as 100 ms. The same silence detector is used to find the location of silence segments. Speech data is further augmented by mixing noise for better classification. Various types of noise signals are mixed in a controlled way with some clean speech samples. Further, Low pass filtering of many speech samples in the speech data is done with a cut-off 2.5 Khz and 4 Khz.

Companding is done for further data augmentation. Telephonic speech signals are companded and expanded. Hence, this type of processed data was important to add in training. Three types of companding are used in augmentation:
1. Exponential companding and expanding. Y=|X|^{α}, \tilde{X}=sign(X)*Y^{1/α}, α=0.5, where X is input and \tilde{X} is companded and expanded reconstructed output. α can have different values but 0.5 is generally used.
2. A law companded and expanded samples are also added in the database.
3. MU law companded and expanded samples are added in the database.

Finally, 21 GB of Speech training data and 7.5 GB of testing data are used for model training.

### Music Database:

In the illustrative embodiment of the present invention, in music database preparation, different type of genre music is accumulated and used in training. 5 GB is training data and 2.75 GB is used in testing. Further, various loop music is added in music training data. It includes different type of scales and chords played by popular instruments. Synthetic harmonic data is also added in training data. Further, music is composed of harmonics and synthetic harmonics (in large amount) can perceptually sound as Noise, therefore model must learn harmonics as music.

The music samples used as input in model generation/prediction is typically in 44100 Hz sample rate, 16 bit-depth, mono channel PCM WAVE format. Hence, all the accumulated music samples are converted in 44100 Hz sample rate, 16 bit-depth, mono channel PCM WAVE audio for further processing and augmentation.

Non-Vocal Music and Vocal Music database:

In the illustrative embodiment of the present invention, in music database preparation, non-vocal music is pure music without any singing/speech/vocals and consists of only musical instruments. Vocal music is singing with music in the background. It is cumbersome to get a direct source of Vocal tagged data, hence much time is dedicated in tagging the same.

Music samples used as input in model generation/prediction are typically in 44100 Hz sample rate, 16 bit-depth, mono channel PCM WAVE format. Hence, all the accumulated music samples are converted in 44100 Hz sample rate, 16 bit-depth, mono channel PCM WAVE audio for further processing, tagging, and augmentation.

An abundant amount of many genre songs such as pop, rock, metal, jazz, classical, rap, EDM, etc. are picked. Using Bhattacharyya distance segmentation is done on each song using script. With the segmentation technique, each song music is divided into music pieces with some in “pure music” and others as “music with singing”. Few pieces will have partial music and singing. Now, these segments are listened and “pure music” and “music with singing” segments are selected accordingly.

Large set of songs is selected with each song having a different band or singer. Songs are listened and a unit rectangular pulse is used for tagging. The reason for using it is that it saves us from writing labels every time decision is done after listening. The steps and rules are as follows
1. Generally, music is repeated in a song. Hence, not full song is tagged but 3-4 segments are created based on interesting music. Tagging is done in approximately 20-30 seconds in start of the song, 20-30 seconds in the end, and if some new music is present at those locations only. The target is to add a variety of training data and not repeated types as it will burden the training computation without enhanced results.
2. Copy of song is created and on that pulses are introduced at appropriate locations for tagging. Adobe Audition is used for listening and tagging. Copy pulse in audition clipboard.
3. One pulse is pasted before start of pure music (1 Ctl+V click)
4. Two pulses are pasted before start of singing/speech (2 Ctl+V click)
5. Three pulses are pasted to mark the end of tagged segment in song (3 Ctl+V click)
6. Four pulses are pasted before start of silence/noise (in the beginning normally silence is there so it can be ignored).
7. Using pulses added song, transitions and vocal regions can easily be identified in original song using correlation or SAD search script.

Mostly vocals are more present as compared to pure music in songs. Therefore, pure instrumental songs are accumulated and added in training database such as band music, drums, guitars, piano, symphony and ensemble music, most important vocal instrument music like flute, saxophone, trumpet etc.

Further, low pass filtering with cut-off 4 Khz is done on many music samples and made part of training data. In practical situations, classification could be required on low-band music signals, hence low pass filtered music data in training is necessary. Finally, 31.7 GB of vocal and non-vocal music data is used for model training and validation.

All above-prepared databases i.e., Noise, Speech, Music, Vocal music, and Non-vocal music arranged for hierarchical models generation as follows:

### Stage-I

First stage is Noise vs Audio classifier. Audio includes second-stage data i.e., Speech and Music. Data used in GB is shown in table

| | | Training | Testing | Total |
|---|---|---|---|---|
| | | data size | data size | per class |
| Class name | Label | (GB) | (GB) | (GB) |
| Noise | 0 | 25.1 | 13.2 | 38.3 |
| Audio | 1 | 41 | 13.85 | 54.85 |
| Total per type | | 66.1 | 27.05 | 93.15 |

### Stage-II

Second stage is Speech vs Music classifier. Music also includes third-stage data i.e., Non-vocal and Vocal music. Data used in GB is shown in table

| | | Training | Testing | Total |
|---|---|---|---|---|
| | | data size | data size | per class |
| Class name | Label | (GB) | (GB) | (GB) |
| Speech | 0 | 21 | 7.46 | 28.46 |
| Music | 1 | 20 | 6.39 | 26.39 |
| Total per type | | 41 | 13.85 | 54.85 |

### Stage-III

Third stage is Non-vocal Music vs Vocal Music classifier. Data used in GB is shown in table

| | | Training | Testing | Total |
|---|---|---|---|---|
| | | data size | data size | per class |
| Class name | Label | (GB) | (GB) | (GB) |
| Non-Vocal | 0 | 6.56 | 2.52 | 9.08 |
| Vocal | 1 | 5.96 | 2.07 | 8.03 |
| Total per type | | 12.52 | 4.59 | 17.11 |

To validate and perform the accuracy tests on the hierarchical classifier, various audio input from varied sources were tested. It was observed that the transition between the 2 classes was not getting accurately mapped in some cases. To improve the transition detection of the classifier, it was proposed to have a new LSTM based model for correcting the transition detection. Therefore, in the classifier of the present invention, a dataset containing no class transition and another dataset containing class transition is used. For preparing a dataset containing no transition, the existing dataset is used which was already used in hierarchical classification and tagged with label 0. For preparing a dataset containing class transition, the data augmentation method is used. The entire database used for model generation for hierarchical classification is used for this. This includes Noise database and Audio database availed in the first stage. (Audio database includes all other class databases like speech, vocal, and non-vocal). All above database is in pure class forms, hence, no class transitions are present except the pulse tagged database. Therefore, pure segments of Non-vocal music are extracted from the pulse tagged database. Vocal part is not extracted from it and added to no class transition database because it has some non-vocal transitions present

In the illustrative embodiment of the present invention, a method of blending is used to create a dataset containing transitions; the method involves the use of a power complementary window for blending at the transition from one class to another. A slice size of 64 frames is used and two power complementary windows of sizes 4096 for Long-blend and 512 for short-blend are used. Below mentioned are the blending steps:
1. Target is to blend class1 slice and class2 slice of 64 frames size each at sample location k (for example 20*1024 sample location i.e., 20^{th} frame) so that transition from class1 to class 2 happens at k location.
2. The blending window size is M (could be 512 or 4096)
3. Take 0 to

$$( k + \frac{M}{4} )$$

samples from class1 slice. Apply the second half part of the window in last M/2 samples to get smoothened samples
4. Take

$$( k - \frac{M}{4} )$$

64*1024 samples from class2 slice. Apply the first half part of the window in starting M/2 samples to get smoothened samples
5. Add class1 and class2 smoothened samples to get a blend region.

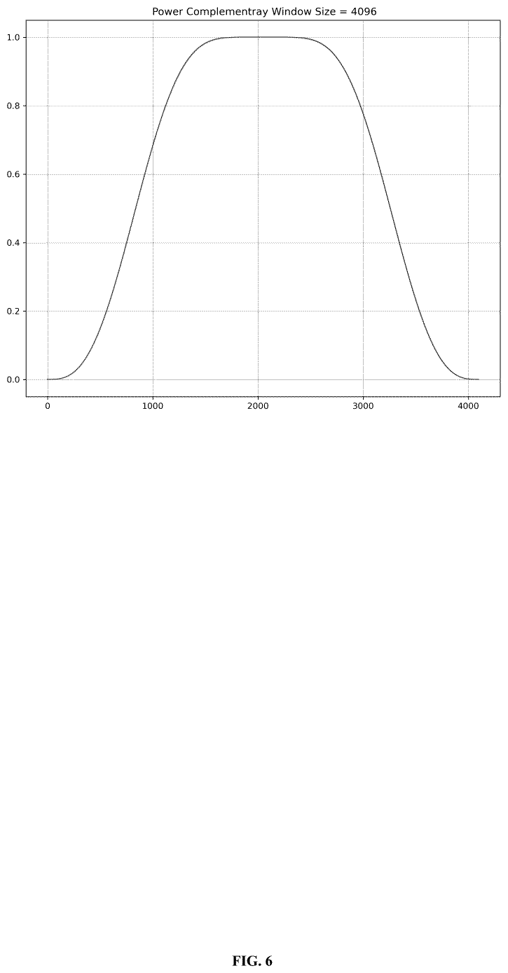

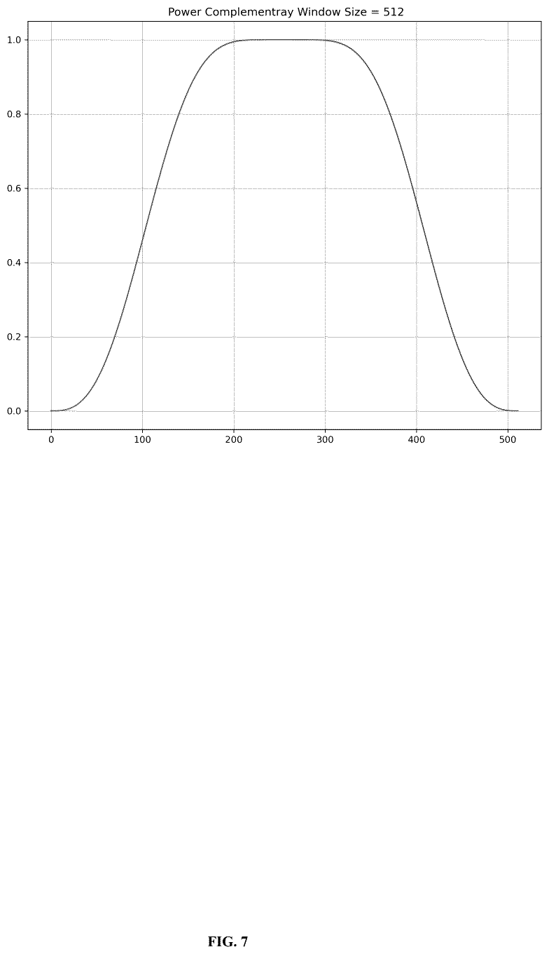

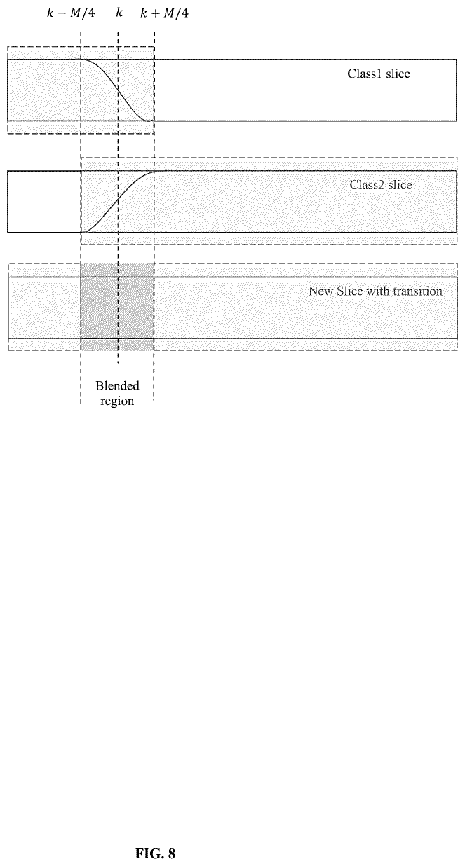

Accordingly, FIG. 6 and FIG. 7 illustrates a graph for blending audio signals showing the plots. Further, FIG. 8 depicts the method for blending the audio signals.

Mixing is another technique used in creating transition dataset, and is, in some ways, more important as compared to blending in some cases because in real signals, one full slice of data is present in the background and other class data starts or ends at some location. For example, in the case of noise and clean speech, blending is too artificial and normally will not exist in real systems. However, clean speech overlapped mixed with noise signals in the background is more realistic. For such type of cases, mixing is used for creating class transition slices. The steps are as follows
1. Let's say, the target is to mix class1 slice y[n] (known as background slice like noise) and class2 slice x[n](known as front signal like clean speech) of 64 frames size each to get transition from class1 to class 2 at sample location k. Class2 is overlapped mixed starting from location k on class1 full slice to get z[n].
2. If we overlap-add directly then final signal can clip and front signal could also be too high in energy as compared to background. Therefore, mixing is done in controlled way such that final slice, z[n] has same energy as x[n](avoids clipping) and non-overlap section is L_{dB} down as compared to overlap mix signal.

$$z [ n ] = α ( x [ n ] + β y [ n ] )$$

z[n] should have same energy as x[n] and z[n](overlap region) should be L_{dB} higher than
αβy[n](non-overlap region), using these constraint α and β can be derived

$$L = α = {10}^{\frac{{L}_{dB}}{{20}^{}}}$$

$$α = \frac{L - 1}{L}$$

$$β = \frac{1}{L - 1} * \frac{{X}_{rms}}{{Y}_{rms}}$$

3. Overlap mix region is z[n]=α(x[n]+βy[n]), where as n=k . . . (64*1024)
4. Non-overlap region is z[n]=αβy[n], where as n=0 . . . k−1

There are four classes noise, speech, vocal, non-vocal music. Following transitions could happen in signal: Speech to Noise and vice-versa, Speech to Non-vocal Music and vice-versa, Speech to Vocal Music and vice-versa, Noise to Non-vocal Music and vice-versa, Noise to Vocal Music and vice-versa, and Non-vocal to Vocal music and vice-versa.

Blending and mixing as described earlier are used for generating a class transition database. The following operations are done based on type of database: Speech to Noise long and short blend and vice versa, Speech to Noise overlap mixing and vice versa, Speech to Non-vocal Music long and short blend and vice versa, Speech to Vocal long and short blend and vice versa, Noise to Non-vocal Music long and short blend and vice versa, Noise to Vocal Music long and short blend and vice versa, Non-vocal to Vocal long and short blend and vice versa, and Non-vocal to Vocal overlap mixing and vice versa.

Speech to Noise transition (vice-versa) and Non-Vocal music to Vocal music transition (vice-versa) should be more reality-based. For a better transition detector, real tagged transition between them is required. Non-vocal to vocal transition or vice versa is extracted from Unit rectangular pulse vocal/music tagged data. Transition slices are extracted from tagged data using a program. At any transition, maximum 56 slices are extracted (with slide from 8th frame to 56th frame) In a clean speech sample wherever a silence segment is detected (could be small size or large size), it is always forced to 64 frame silence. On top of that background noise is added to full sample. After that speech vs noise, transition slices are created knowing where silence (noise) is present.

In the illustrative embodiment of the present invention, database normalization is vital in machine learning, model generation, and model validation. Providing input audio without normalization will generate a weak ML model and it will learn the classification dependent on audio loudness level. Even, an attenuated, or amplified version of the training sample would have bad classification results. Thus, audio normalization is an essential process to be done before training and prediction.

Global loudness normalization is not feasible because the target is to build a real-time prediction system. Hence, applied a short-term loudness audio normalization technique using a previously developed ITU BS1770-3 [International Telecommunication Union, Recommendation ITU-R BS. 1770-3, “Algorithms to measure audio program loudness and true-peak audio level”, Broadcast Standards series] compliant short-term audio normalization tool for generating better models and classification results. Audio normalization is applied at each audio frame level (1024 audio samples). Only 3 future audio frames are used in loudness control (approximately 93-millisecond delay is introduced in real-time systems using our AGC loudness module). The following parameters are used in Automatic Gain Control (AGC) processing

| Parameter name | Value | |
|---|---|---|
| Release Time | 0.1 | second |
| Attack Time | 0.466666669 | millisecond |
| Target Level | 0.533333361 | |
| Processing Level | 0.9 | |
| Noise Level | −80.0 | dB |

Audio frame features generated after loudness normalization are now irrelevant to any global gain applied on the input sample. For example, −10 dblkfs sample and −40 dblkfs attenuated sample have a similar value of audio features per frame. In real-time audio systems, the user can change the gain of audio capture at any time, therefore real-time short segment loudness control has an important role to play in normalizing the audio before class prediction.

The classification model is best if it detects the signal type even if the audio is low quality or distorted. The trained model should have the capability of classifying audio with low bandwidth. Speech signal has bandwidth up to 8 KHz only and music has higher bandwidth than 8 KHz. If 8 Khz band-limited music is provided to the model, it will get confused and can classify it in the speech signal. As a result, every audio input is band limited to 8 KHz before model training and prediction. 8th order IIR filter is used for 8 KHz low pass filtering with the following filter coefficients.

In the illustrative embodiment of the present invention, an audio classification engine requires audio-based frame features as input. In the disclosed model, pcm samples at a sampling rate of 44.1 kHz and 16-bit encoding are taken as input. For frame feature generation, 2048 raw pcm samples are taken and a Hanning window, of the same length, is applied. Further, 2048 length DFT is carried out using FFT algorithm, and first 1024 samples are taken for feature generation as taken for evaluation of each frame feature. The input is passed through 8 kHz low pass filter, before the calculation of frame features is carried out. There are a total of 62 frame features, which imbibe the temporal and spectral characteristics of the input audio. For calculation of some of these features, the spectral frequencies are divided into 25 critical bands, as shown in table below:

TABLE II
Critical Bands & Bins

| | fᵢ | fₕ | | |
|---|---|---|---|---|
| Band | (Hz) | (Hz) | bᵢ | b_{f} |
| 0 | 0 | 100 | 0 | 5 |
| 1 | 100 | 200 | 5 | 9 |
| 2 | 200 | 300 | 9 | 14 |
| 3 | 300 | 400 | 14 | 19 |
| 4 | 400 | 510 | 19 | 24 |
| 5 | 510 | 630 | 24 | 29 |
| 6 | 630 | 770 | 29 | 36 |
| 7 | 770 | 920 | 36 | 43 |
| 8 | 920 | 1080 | 43 | 50 |
| 9 | 1080 | 1270 | 50 | 59 |
| 10 | 1270 | 1480 | 59 | 69 |
| 11 | 1480 | 1720 | 69 | 80 |
| 12 | 1720 | 2000 | 80 | 93 |
| 13 | 2000 | 2320 | 93 | 108 |
| 14 | 2320 | 2700 | 108 | 125 |
| 15 | 2700 | 3150 | 125 | 146 |
| 16 | 3150 | 3700 | 146 | 172 |
| 17 | 3700 | 4400 | 172 | 204 |
| 18 | 4400 | 5300 | 204 | 246 |
| 19 | 5300 | 6400 | 246 | 297 |
| 20 | 6400 | 7700 | 297 | 358 |
| 21 | 7700 | 9500 | 358 | 441 |

In the above table, fᵢ & fₕ represents the initial and final frequencies respectively and bᵢ & bₕ are the initial and final bins respectively, of a critical band. Since, we are making our input audio limited to 8 kHz bandwidth, hence the last band is taken up in this range.

Energy per critical band: After obtaining the FFT of size 1024, for calculation of some of the spectral frame features, energy per critical band E_{PC} is calculated based on the critical bands defined in table-II.

$${E}_{PC} ( i ) = \frac{1}{{( {Len}_{FFT} / 2 )}^{2} * ( {b}_{f} ( i ) - {b}_{i} ( i ) )} {\sum }_{j = {b}_{i}}^{{b}_{h}} ( {Re}^{2} [ j ] + {Im}^{2} [ j ] )$$

Where, j=0,.21
Len_{FFT}=2048
bᵢ=initial bin number
b_{f}=final bin number
   Re[j]=Real part of FFT at bin number j
   Im[j]=Imaginary part of FFT at bin number j
Energy per bin: Energy per frequency bin is calculated as:
   Power Spectrum/Energy per bin: It is calculated as energy per frequency bin. Mathematically, it is defined as:

$${E}_{bin} = PS ( i ) = \frac{1}{{( {Len}_{FFT} / 2 )}^{2}} ( {Re}^{2} [ i ] + {Im}^{2} [ i ] )$$

Where, i=0, 1, 2 . . . , 1023
Other symbols have their usual meaning as defined in the energy per critical band section.

In the illustrative embodiment of the present invention, audio features for LSTM model input are described below in detail. More detailed description of these features may be found in [Steven M. Kay, Fundamentals of Statistical Processing: Estimation Theory, Volume 1, 1st edition, ISBN-13: 9780133457117], [D. R. Brilenger, Time Sries, Data Analysis and Theory, Expanded Edition, Holden-Day Inc, San Francisco], [J. M. Mendel, “Tutorials on higher-order statistics (spectra) in signal processing and system theory: Theoretical results and some applications,” Proc. Of IEEE, vol. 79, no. 3, pp 277-305, March 1991], [3GPP TS 26.445 3rd Generation Partnership Project; Technical Specification Group Services and System Aspects; Codec for Enhanced Voice Services (EVS); Detailed Algorithmic Description (Release 17)], and [Min Xu; et al. (2004). “HMM-based audio keyword generation”. In Kiyoharu Aizawa; Yuichi Nakamura; Shin'ichi Satoh (eds.). Advances in Multimedia Information Processing—PCM 2004: 5th Pacific Rim Conference on Multimedia. Springer. ISBN 978-3-540-23985-7]. A person with ordinary skill in the art will recognize that the use of this specific set of features is not limiting to the scope of the present invention, and other features may also be used in conjunction with the techniques taught herein:
1) Root mean square: It determines the strength of the signal in terms of its magnitude. The mathematical formula is given as:

$$\sqrt{\frac{1}{n} ( {x}_{1}^{2} + {x}_{2}^{2} + ⋯ + {x}_{n}^{2} )}$$

where, x₁, x₂, . . . , xₙ are PCM samples and n=1024.
2) Zero crossing rate: It is the rate of sign changes in a frame duration. Mathematically it is defined as:

$$ZCR = \frac{1}{2 N} {\sum }_{n = 0}^{N - 1} \vert sgn [ x ( n ) ] - sgn [ x ( n - 1 ) ] \vert$$

Where, sgn[x(n)] is signum function.
3) Spectral crest factor: It measures the peaks in the power spectrum. It is observed that tonal sounds have a high spectral crest factor value when compared to noise. It is given as:

$$SCF = \frac{( a ( k ) )}{\frac{1}{K} {\sum }_{1}^{K} a ( k )}$$

Where, a(k) is the power spectrum in the frequency band whose length is K.
4) Spectral flatness: It measures the flatness or roughness of the power spectrum. It is evaluated as the ratio of geometric mean to arithmetic mean of power spectrum values.

$$S F = \frac{{( {\prod }_{1}^{K} a ( k ) )}^{1 / K}}{\frac{1}{k} {\sum }_{1}^{K} a ( k )}$$

5) Spectral entropy: It computes Shannon entropy using power spectrum amplitude values. It is mathematically given as:

$$P ( {ω}_{i} ) = \frac{1}{N} {\vert X ( {ω}_{i} ) \vert}^{2}$$

Where, P(ωᵢ) is the power spectrum density.

$${p}_{i} = \frac{P ( {ω}_{i} )}{{\sum }_{1}^{K} P ( {ω}_{i} )}$$

Where, pᵢ is the spectral probability density
Finally, the spectral entropy is given as

$$S E = - {\sum }_{i = 0}^{N - 1} {p}_{i} ln ( {p}_{i} )$$

6) Spectral centroid: It provides information about the center of gravity of spectral energy. It is mathematically represented as:

$$S C = \frac{{\sum }_{k = {b}_{1}}^{{b}_{2}} {f}_{k} {S}_{k}}{{\sum }_{k = {b}_{1}}^{{b}_{2}} {S}_{k}}$$

Where, fₖ is k^{th} frequency bin and Sₖ is the spectral magnitude at k^{th} frequency bin. b₁& b₂ are band edges.
7) Spectral spread: It describes the concentration of the power spectrum around the spectral centroid. It is calculated as standard deviation of power spectrum around the spectral centroid. It is mathematically given as [1]:

$$S S = \sqrt{\frac{{\sum }_{k = {b}_{1}}^{{b}_{2}} {( {f}_{k} - {μ}_{1} )}^{2} {S}_{k}}{{\sum }_{k = {b}_{1}}^{{b}_{2}} {S}_{k}}}$$

Where, μ₁=spectral centroid and rest symbols have the usual meaning as described in the spectral centroid section.
8) Spectral skewness: It measures the asymmetry of the spectrum around its spectral centroid. It is mathematically given as:

$$Skewness = \frac{{\sum }_{k = {b}_{1}}^{{b}_{2}} {( {f}_{k} - {μ}_{1} )}^{3} {S}_{k}}{{μ}_{2}^{3} {\sum }_{k = {b}_{1}}^{{b}_{2}} {S}_{k}}$$

Where, μ₂=spectral spread and other symbols have their usual meaning.
9) Spectral kurtosis: It describes the flatness of the spectrum around its mean/centroid value. It is mathematically given as:

$$Kurtosis = \frac{{\sum }_{k = {b}_{1}}^{{b}_{2}} {( {f}_{k} - {μ}_{1} )}^{4} {S}_{k}}{{μ}_{2}^{4} {\sum }_{k = {b}_{1}}^{{b}_{2}} {S}_{k}}$$

Where, the symbols have their usual meanings
10) Spectral Slope: It is a measure of slope of spectral shape. It is mathematically defined as:

$$Slope = \frac{{\sum }_{k = {b}_{1}}^{{b}_{2}} ( {f}_{k} - {μ}_{f} ) ( {S}_{k} - {μ}_{s} )}{{\sum }_{k = {b}_{1}}^{{b}_{2}} {( {f}_{k} - {μ}_{f} )}^{2}}$$

Where, μ_{f}=mean of frequency bins, Sₖ=Energy in k^{th} frequency bin in db, and μₛ=mean of Energy in db. Rest of symbols have their usual meaning.
11) Spectral Increase/Decrease: It measures the rising steepness of spectrum envelope over a frequency range.

$$Value = \frac{{\sum }_{k = {b}_{1} + 1}^{{b}_{2}} \frac{{E}_{k} - {E}_{{b}_{1}}}{k - 1}}{{b}_{2} - {b}_{1}}$$

Where, Eₖ is the energy per bin in db and b₁, b₂ are band edges.
If the value >0, then it results in Spectral Increase. If the value <0, then it results in spectral decrease.
12) Signal Non-Stationarity/Energy Non-Stationarity: It gives information about the stationarity of signal in terms of its energy, which is calculated as per critical band. Energy per critical band is calculated first, by summing over the energy per bins for all the bins falling in that particular critical band. In this way we obtain E_{PC}, which is energy per critical band of a current frame. Also, the E_{PC}⁻¹ denotes the energy per critical band of previous frame. In order to obtain the signal non-stationarity of current frame, we sum the difference between the E_{PC} and E_{PC}⁻¹ for over 2 to 15 critical bands, which are defined in table-II.

$$Signal non - stationarity = \frac{1}{14} {\sum }_{i = 2}^{15} \vert log ( {E}_{P C} ( i ) ) - log ( {E}_{P C}^{- 1} ( i ) ) \vert$$

13) Spectral Non-stationarity/Power Non-stationarity: It contains the non-stationarity information of the signal in terms of its power. Let dPS(i) be the i^{th} bin spectral difference between the present (PS(i)) and past frame (PS⁻¹(i)).

$$d P S ( i ) = \vert PS ( i ) - {PS}^{- 1} ( i ) \vert$$

$$Spectral non - stationarity = log {\sum }_{i = 9}^{357} \frac{max ( P S ( i ) , P {S}^{- 1} ( i ) )}{d P S ( i )}$$

14) Spectral difference/Power Spectral deviation/Delta Power spectrum/Log spectral deviation: It contains the logarithmic information about the power spectrum difference among the current and past frames.

$$Spectral difference = 20 log ( {\sum }_{i = 9}^{357} d P S ( i ) ) + 20 log ( {\sum }_{i = 9}^{357} d P {S}^{- 1} ( i ) )$$

Where, dPS⁻¹(i) is the i^{th} bin spectral difference of the past frame.
15) Line Spectral Frequencies: Using the Levinson durbin algorithm, LP residual error energies “Eₗₚ” and LP filter coefficients “aₖ” are obtained. These LP filter coefficients are converted to line spectral pairs (LSPs), which are roots of the sum and difference polynomials:

$${F}_{1} ( z ) = \frac{A ( z ) + {z}^{- 16} A ( {z}^{- 1} )}{1 + {z}^{- 1}}$$

$${F}_{2} ( z ) = \frac{A ( z ) - {z}^{- 16} A ( {z}^{- 1} )}{1 - {z}^{- 1}}$$

Using Chebyshev polynomial, the roots of the F₁(z) and F₂(z) are found.
Five LSF parameters are obtained from the LSP as per relation

$$LPC Residual Ratio = log \{ ( \frac{{E}_{tp} ( 13 )}{{E}_{tp} ( 1 )} ) * ( \frac{{E}_{tp}^{- 1} ( 13 )}{{E}_{tp}^{- 1} ( 1 )} ) \}$$

Where, lsp⁻¹(i) represents the LSP of previous frame.
16) Linear prediction coefficient residual ratio/LP error energies ratio: Using the LP residual error energies, a ratio is obtained as follows:

$$L P C Residual Ratio = log \{ ( \frac{{E}_{l p} ( 13 )}{{E}_{l p} ( 1 )} ) * ( \frac{{E}_{l p}^{- 1} ( 13 )}{{E}_{l p}^{- 1} ( 1 )} ) \} \qquad ( 13 )$$

17) Tonal Stability: It evaluates the stability of tones in consecutive multiple frames in audio signals, especially music.
   First the energy per bin is calculated in db.

E_{bindb}=10 log log(E_{bin})
Indices of local minima are searched through the spectrum. An array of local minima indices are obtained and stored in indₘᵢₙ. Let the number of local minima indices be Nₘ. Second a spectral function based on local minima indices, which connects these minima points using a straight line. Hence, a straight line between 2 consecutive minima indices is given by:

$$s f ( i ) = m * ( i - i n {d}_{min} ( j ) ) + c$$

Where, i∈[indₘᵢₙ(j), indₘᵢₙ(j)]

$$m = \frac{{E}_{b i n d b} ( i n {d}_{min} ( j + 1 ) ) - {E}_{b i n d b} ( i n {d}_{min} ( j ) )}{i n {d}_{min} ( j + 1 ) - i n {d}_{min} ( j )} \\ \\ c = {E}_{b i n d b} ( i n {d}_{min} ( j ) )$$

In case sf(i)>E_{bindb}, then sf(i)=E_{bindb}
Now, energy spectral ground is constructed using the above spectral function, in following way:
   i) SF(i)=E_{bindb}(i), For i=0, . . . , indₘᵢₙ(0)−1
   ii) SF(i)=sf(i), For i=indₘᵢₙ(0), . . . , indₘᵢₙ(Nₘ−1)−1
   iii) SF(i)=E_{bindb}(i), For i=indₘᵢₙ(Nₘ−1), . . . , 1023
The energy spectral ground is subtracted from the energy spectrum in order to get the energy spectrum deviation.

$$Δ {E}_{b i n d b} ( i ) = {E}_{b i n d b} ( i ) - S F ( i )$$

Where, i=0, 1 . . . , 1023.
Using the energy spectral ground of current and previous frame, mapping function is calculated as follows:

$$M ( i n {d}_{min} ( i ) , i n {d}_{min} ( i + 1 ) ) = \frac{{( \begin{matrix}{Σ}_{k = {in d}_{min} ( i )}^{{in d}_{min} ( i + 1 ) - 1} & Δ {E}_{b i n d b} ( k )\end{matrix} Δ {E}_{bind b}^{- 1} ( k ) )}^{2}}{\begin{matrix}{Σ}_{k = {in d}_{min} ( i )}^{{in d}_{min} ( i + 1 ) - 1} & {Δ {E}_{b i n d b} ( k ) )}^{2} & {Σ}_{k = {in d}_{min} ( i )}^{{in d}_{min} ( i + 1 ) - 1} & {( Δ {E}_{bind b}^{- 1} ( k ) )}^{2}\end{matrix}}$$

Where, ΔE_{bindb}⁻¹(k)=Energy spectral ground of previous at k^{th} bin.
In this way, the mapping function is obtained for current and previous frames and used for the final calculation of tonal stability.

### Tonal Stability

$$= \begin{matrix}\frac{1}{358} {\sum }_{i = 0}^{358} & ( M ( i n {d}_{min} ( i ) , i n {d}_{min} ( i + 1 ) ) + {M}^{- 1} ( i n {d}_{min} ( i ) , i n {d}_{min} ( i + 1 ) ) )\end{matrix}$$

Where, M⁻¹(indₘᵢₙ(i), indₘᵢₙ(i+1))=Mapping function of previous frame.
18) MFCC: Mel frequency cepstral coefficients are very powerful feature vector because the frequency bands are based on the mel scale, which maps the human auditory response better. In our work, we had concentrated on first 13 MFCCs.
19) Weighted MFCC: In order to capture the essence of the MFCCs based on different class of audio, a weighted MFCC feature is developed. Here, mean of each of the MFCC coefficients over entire dataset is taken and used as weights. The weighted MFCC is given by:

$$\begin{matrix}Weighted MFCCs = {μ}_{m fcc 0} * m fcc 0 + {μ}_{m fcc 1} * m fcc 1 + {μ}_{m fcc 2} * m fcc 2 + {μ}_{m fcc 3} * m fcc 3 \\ + {μ}_{m fcc 4} * m fcc 4 + {μ}_{m fcc 5} * m fcc 5 + {μ}_{m fcc 6} * m fcc 6 + {μ}_{m fcc 7} * m fcc 7 \\ + {μ}_{m fcc 8} * m fcc 8 + {μ}_{m fcc 9} * m fcc 9 + {μ}_{mfcc 10} * m fcc 10 + {μ}_{m fcc 11} * m fcc 11 \\ + {μ}_{m fcc 12} * m fcc 12\end{matrix}$$

20) Distance Measure: This feature calculates the intra-frame distance between the line spectral pairs of 2 subframes within a frame.

$$Distance Measure = {\sum }_{i = 0}^{9} {( l s {p}_{i}^{1} - l s {p}_{i}^{2} )}^{2}$$

Where, lspᵢ=line spectral pairs, with varying from i=0 to 9.
lsp¹ & lsp2 are the line spectral pairs of 1^{st} and 2^{nd} subframes respectively. Each of subframes is consists of 512 pcm samples.
21) Theta: It calculates the inter-frame distance between the line spectral pairs between the current and previous frames.

$$θ = {\sum }_{i = 0}^{9} {( l s {p}_{i} - l s {p}_{i}^{- 1} )}^{2}$$

Where, lspᵢ is the i^{th} lsp of current frame
lspᵢ⁻¹ is the i^{th} lsp of previous frame.
22)Intra-frame Non-Stationarity: This feature calculates the energy non-stationarity between 2 subframes. The subframe consists of 512 pcm samples. In a 1024 pcm samples frames, the 1^{st} 512 pcm samples constitutes the 1^{st} subframe and rest of the 512 pcm samples constitute the 2^{nd} subframe. Energy per critical band, using ODFT of size 512 (Len_{FFT}=512), is calculated for each of the subframe in similar manner as described previously. Let E_{PCS1} & E_{PCS2} be the energy per critical band of 1^{st} & 2^{nd} subframe respectively.

$$Intra - Frame non - stationarity = \frac{1}{14} {\sum }_{i = 2}^{15} \vert log ( {E}_{PCS 1} ( i ) ) - log ( {E}_{PCS 2} ( i ) ) \vert$$

23) Harmonic Based Tonality: It is calculated as the ratio of tonal power to total power per frame. Let there be ‘N’ tones in current frame and P_{TP}(i) be the power of the i^{th} tone. Then, Harmonic based tonality is given by:

$$Harmonic Based Tonality = \frac{{\sum }_{i = 0}^{N - 1} {P}_{T P} ( i )}{{\sum }_{i = 0}^{1023} P S ( i )}$$

24) Number of Pitch: It calculates the number of pitches per frame
25) Roll-off frequency: It is the frequency up to which the total power content of the frame is greater than or equal to 85% of total power in a frame. Let the total power contained till n^{th} bin be greater than or equal to 85% of total power
26) Envelope Coherence: It is calculated by passing the incoming frames through a 3.5 kHz low pass filter and 3.5 kHz high pass filter. Further, Hilbert transform of these 2 filtered signals, i.e., lower envelope and upper envelope, are obtained. Magnitude of the 2 Hilbert transforms is obtained and passed through moving average smoothing filter of length=25. This results in upper and lower smoothened moving average envelopes. Now, correlation between these 2 smoothened average envelopes is obtained. In this way, envelope coherence per frame is calculated. In order to capture the envelope coherence at sub-frame level, the 1024 length frame is divided into 4 sub-frames, each of equal length=256. The same process of calculation of envelope coherence is carried out for each of the 4 sub-frames which gives 4 sub-frame envelope coherence. Thus, a total of 5 envelope coherence values are obtained per frame.
27) Cepstrum based frame features: Using the cepstrum algorithm, 1024 cepstrum values are obtained per frame. In cepstrum domain, we have inverted frequency—quefrency. In order to capture the essence of cepstrum for discrimination between different classes, the quefrency has been divided into bands and taken piano key frequencies as reference.
   10 quefrency bands have been divided into 3 bands, namely:
i) Band1 ∈[0, 25)
ii) Band2 ∈[25, 100)
iii) Band3 ∈[100, 1024)
   In the Band3, we had taken till 1024 quefrency, which is equivalent to 43 Hz.
   In each of these 3 quefrency bands, cepstrum statistical features are calculated. These statistical features are:
i) Cepstrum crest factors
ii) Cepstrum Centroid
iii) Cepstrum Spread
iv) Cepstrum Skewness
v) Cepstrum Kurtosis
   So, a total of 15 cepstrum based features are calculated for every incoming frame.

In the illustrative embodiment of the present invention, all over 62 frame features per frames are calculated. Each LSTM model stage uses different set of features as input. Feature set for each classifier stage is derived using discrimination potential and correlation analysis.

To evaluate the discrimination potential of the frame features with respect to different classes, we have used various discrimination potentials and distance formulation.
1. Using the distance between the histograms of each of the binary classes at each of the stage as a discrimination potential of a frame feature, which is mathematically given as:

$$D {P}_{ftr} = \frac{1}{2} {\sum }_{i = 0}^{256} \vert His {t}_{i}^{C l ass 1} - H i s {t}_{i}^{C l ass 2} \vert$$

Where, DP_{ftr}, is the discrimination potential of the feature ftr and Histicᵢ^{Class1} and Histicᵢ^{Class2} are the histogram at it bin of class1 and class2 respectively. We had taken 256 bins. DP_{ftr}=0 for no discrimination and DP_{ftr}=1 for maximum discrimination
2. Using correlation

In an embodiment of the present invention, in stage I, using the discrimination potential and correlation matrix, best 24 frame features are selected for training the deep learning model. List of selected frame features is

| S. No. | Feature Name |
|---|---|
| 1 | RMS |
| 2 | Spectral Crest Factor |
| 3 | Spectral Centroid |
| 4 | Spectral Slope |
| 5 | Spectral Increase |
| 6 | Spectral Decrease |
| 7 | Spectral Non-stationarity |
| 8 | Signal Non-Stationarity |
| 9 | Number of Pitch |
| 10 | Harmonics based Tonality |
| 11 | Tonal Stability |
| 12 | MFCC0 |
| 13 | MFCC2 |
| 14 | MFCC9 |
| 15 | MFCC12 |
| 16 | LSF0 |
| 17 | Cepstrum Crest Factor in Band2 |
| 18 | Cepstrum Crest Factor in Band3 |
| 19 | Cepstrum Spread in Band3 |
| 20 | Cepstrum Skewness in Band2 |
| 21 | Cepstrum Kurtosis in Band1 |
| 22 | Theta |
| 23 | Intra-frame Non-Stationarity |
| 24 | Envelope Coherence |

Each of 24 features are normalized with mean 0 and standard deviation=1

In an embodiment of the present invention, all 62 audio frame features are used as input for Model training in second stage.

In an embodiment of the present invention, all 62 audio frame features are used as input for Model training in third stage.

### Audio Features Normalization:

In the illustrative embodiment of the present invention, 62 frame features could have a different range from one another. For example, x feature has a range [0.0, 1.0], y has a range [10000, 1e10], providing these directly as input in model training will not be a good idea as the model could give priority to large numbers and x will lose importance in training. Hence, it is crucial to normalize all audio features and make a similar range for all of them. The following method is used for normalizing the features:

Training observations (or total frames in database) N
No of features per frame K
Feature array is X (it will have dimension N×K)
Calculate kth feature mean of all N frames,

$$m u [ k ] = \frac{\begin{matrix}{Σ}_{n = 1}^{N} & X [ n , k ]\end{matrix}}{N}$$

Calculate kth feature standard deviation of all N frames

$$std [ k ] = \sqrt[2]{\frac{{\begin{matrix}{Σ}_{n = 1}^{N} & ( X [ n , k ]\end{matrix} - mu [ k ] )}^{2}}{N}}$$

One frame of audio features is normalized as follows (this equation is used in prediction also)

$$X [ n , k ] = \frac{X [ n , k ] - m u [ k ]}{s t d [ k ]}$$

mu and std are vectors with dimension K. These are saved and used in real-time prediction process.

In the illustrative embodiment of the present invention, different type of machine learning models designing and training with various hyper-parameters is carried out. Finally, the best design and hyper-parameters are chosen for accurate results.

### Stage I (Noise Vs Audio)

In stage I, the input to the model is an audio slice of 64 frames each having 24 features. Further, the dense layer has a sigmoid as activation, which means it will output a value in the range 0-1. (0 for Noise, and 1 for Audio). Hence, the labeling is integer encoding i.e., 0 for Noise and 1 for Audio. Further, 2nd LSTM layer has a return sequence TRUE, which implies that the last Dense layer will output classification output for all 64 frames in a slice. Therefore, labeling for each frame is required in training the model.

Below mentioned are the training hyper parameters:

| Hyper parameter | Val |
|---|---|
| Optimizer Algorithm | Adam |
| Learning rate | Default |
| Loss function | Binary cross entropy |
| Quality metric | accuracy |
| Batch size | 32 |
| Epochs | 100 |

Some of the accuracy results at each epoch are

STAGE-I

| Epoch | Training | Testing |
|---|---|---|
| No. | Accuracy | Accuracy |
| 1 | 97.83% | 96.81% |
| 2 | 98.16% | 97.21% |
| 3 | 98.39% | 97.69% |
| 4 | 98.55% | 97.68% |
| 5 | 98.51% | 97.31% |
| 6 | 98.64% | 97.55% |
| 7 | 98.75% | 97.95% |
| 8 | 98.77% | 97.59% |
| 9 | 98.77% | 96.44% |
| 10 | 98.79% | 95.47% |
| 11 | 98.82% | 96.40% |

7^{th} epoch model is chosen as final model for Stage-I classification and prediction in real-time systems.

### Stage II (Speech vs Music)

In stage II, the input to the model is an audio slice of 64 frames each having 62 features. The last dense layer uses the SoftMax activation function and outputs 2 relative probabilities values, one each for the Speech and Music class respectively. Hence, the labeling is hot encoding i.e., 10 for Speech and 01 for Music. Further, 2^{nd} LSTM layer has a return sequence TRUE, which implies that the last Dense layer will output classification probabilities for all 64 frames in a slice. Therefore, labeling for each frame is required in training the model.

Below mentioned are the used training hyper parameters:

| Hyper parameter | Val |
|---|---|
| Optimizer Algorithm | Adam |
| Learning rate | Default |
| Loss function | Categorical cross entropy |
| Quality metric | accuracy |
| Batch size | 32 |
| Epochs | 100 |

Some of the accuracy results at each epoch are

STAGE-II

| Epoch | Training | Testing |
|---|---|---|
| No. | Accuracy | Accuracy |
| 1 | 99.31% | 98.12% |
| 2 | 99.49% | 98.38% |
| 3 | 99.56% | 98.19% |
| 4 | 98.60% | 98.23% |
| 5 | 99.62% | 98.49% |
| 6 | 99.69% | 98.25% |
| 7 | 99.70% | 98.04% |

5^{th} epoch model is chosen as the final model for Stage-II classification and prediction in real-time systems.

### Stage III (Non-Vocal vs Vocal Music)

In stage III, the input to the model is an audio slice of 64 frames each having 62 features. The last dense layer uses the SoftMax activation function and outputs 2 relative probabilities values, one each for non-vocal and vocal classes respectively. Hence, the labeling is hot encoding i.e., 10 for non-vocal and 01 for vocal music. Further, 2^{nd} LSTM layer has a return sequence FALSE, which implies that the last Dense layer will output classification probabilities for the last frame in a slice. Therefore, labeling for the last frame (or a single label for a slice) is required in training the model.

Below mentioned are the used training hyper parameters:

| Hyper parameter | Val |
|---|---|
| Optimizer Algorithm | Adam |
| Learning rate | Default |
| Loss function | Categorical cross entropy |
| Quality metric | accuracy |
| Batch size | 32 |
| Epochs | 10 |

Some of the accuracy results at each epoch are

STAGE-III

| Epoch | Training | Testing |
|---|---|---|
| No. | Accuracy | Accuracy |
| 1 | 94.52% | 91.31% |
| 2 | 95.24% | 92.26% |

2^{nd} epoch model is chosen as final model for Stage-III classification and prediction in real-time systems.

### Class Transition (No Transition Vs Transition)

In class transition, the input to the model is an audio slice of 64 frames each having 62 features. The last dense layer uses the SoftMax activation function and outputs 2 relative probabilities values, one each for no transition and transition class respectively. Hence, the labeling is hot encoding i.e., 10 for no transition and 01 for transition. Further, 3^{rd} LSTM layer has return sequence FALSE, which implies that the last dense layer will output classification probabilities only for last frame in a slice. Therefore, labeling for last frame (or single label for a slice) is required in training the model.

Below mentioned are the used training hyper parameters:

| Hyper parameter | Val |
|---|---|
| Optimizer Algorithm | Adam |
| Learning rate | Default |
| Loss function | Binary cross entropy |
| Quality metric | accuracy |
| Batch size | 32 |
| Epochs | 100 |

Some of the accuracy results at each epoch are:

TRANSIENT DETECTOR

| Epcoh | Training | Testing |
|---|---|---|
| No. | Accuracy | Accuracy |
| 1 | 86.91% | 89.31% |
| 2 | 90.80% | 91.50% |
| 3 | 92.28% | 92.74% |
| 4 | 92.81% | 93.16% |
| 5 | 93.57% | 93.36% |
| 6 | 93.63% | 93.35% |
| 7 | 93.95% | 93.87% |
| 8 | 93.98% | 93.85% |
| 9 | 94.66% | 94.36% |
| 10 | 94.64% | 93.86% |
| 11 | 94.86% | 94.37% |
| 12 | 94.91% | 94.55% |
| 13 | 94.87% | 94.22% |

12^{th} epoch model is chosen as the final model for class transition detector and prediction in real-time systems.
Real-time audio class prediction using stateful LSTM predictors:

In an embodiment of the present invention, the stateless prediction algorithm steps are as follows:
1. n^{th} audio frame arrives in system
2. Above audio frame is passed in short term loudness control module. Loudness control module emits (n−4)^{th} normalized audio frame.
3. Above output audio frame is low pass filtered at 8 Khz using 8^{th} order IIR filter.
4. 62 frame features are calculated using above frame. All features are normalized using mu and std vectors (which are computed while training process).
5. 62 frame normalized features are saved in 2D FIFO buffer of dimension 64×62. This FIFO buffer holds 64 frames of normalized audio features. It will discard the oldest frame. Now, FIFO buffer will hold features of (n−4)^{th} to (n−4−63)^{th} frames.
6. If already transient location is present within (n−4)^{th} to (n−4−63)^{th} frame at (n−4−k)^{th}, then use that location for further processing. If transient is already present then go to step 8, else if go to next step.
7. Run class transition classifier (Predict if class transition is present or not). The transition detector Model will use all FIFO frame features (64 frames slice) for determining if any class transition is present in the slice. Let's say transition is detected, which implies that transition location could be between (n−4)^{th} to (n−4−8)^{th} frames. Using spectrum flux method on latest 8 frames in slice, determine exact class transition frame location. Let's say transition is at (n−4−k)^{th}
8. Run Stage-I Noise vs Audio classifier. First extract 24 features (specifically for this classifier) of frame (n−4)^{th} available in input FIFO. Provide 1×24 feature frame as input in stage-I LSTM prediction. If class transition location is available in this slice at (n−4−k)^{th}, and in last 64 frames states was not reset, then reset the states in every LSTM layer at this location when doing prediction.
9. Stage-I classifier will give one frame class prediction. Conclude that if it is NOISE or AUDIO. If decision is NOISE, then assign (n−4)^{th} frame LABEL as NOISE and go to step 14, else if AUDIO is predicted go to next step for second stage classifier.
10. Run Stage-II Speech vs Music classifier. Extract all 62 features from all frames (n−4)^{th} available in input FIFO. Provide 1×62 feature frame as input in stage-II LSTM prediction. If class transition location is available in this slice at (n−4−k)^{th}, and in last 64 frames states was not reset, then reset the states in every LSTM layer at this location when doing prediction.
11. Stage-II classifier will give one frame class prediction probabilities. Take decision that if they are SPEECH or MUSIC. If decision is SPEECH, then assign (n−4)^{th} frame LABEL as SPEECH and go to step 14, else if MUSIC is predicted go to next step for third stage classifier.
12. Run Stage-III Non-vocal vs Vocal music classifier. Extract all 62 features from all frames (n−4)^{th} frame available in input FIFO. Provide 1×62 feature frame as input in stage-III LSTM prediction. If class transition location is available in this slice at (n−4−k)^{th}, and in the last 64 frames states was not reset, then reset the states in every LSTM layer at this location when doing prediction.
13. Stage-III classifier will give one frame class prediction probabilities. Conclude that if it is NON-VOCAL or VOCAL music and assign it to (n−4)^{th} frame LABEL.
14. Send out(n−4)^{th} frame Label value to the system. (Hence, when n^{th} frame arrives, output decision of (n−4)^{th} frame goes out, which implies delay of 4 audio frames is present in system).
15. Continue with step 1 until no data arrives.

Below mentioned are the few non-limiting applications of the disclosed audio-classifier:
1. Band loudness-controlled processing. Based on type of signal detected, suitable loudness control filter can be applied in each audio band.
2. Vocal/singing/dialogues/speech enhancement. Based on Vocal detection or speech detection in a frame, enhancement can be applied in vocal/speech bands.
3. Music enhancement. Similarly, bass/treble enhancement and instrument music enhancement could be applied if pure music is detected.
4. Stereo image enhancement. Based on signal type, various stereo separation can be done, for example, if pure music is there then more stereo separation can be done as compared to the audio where speech is present.
5. Auto profile set in receivers based on signal detected (TV, smartphones, Tablets). Nowadays, it is desirable to automatically adjust the loudness of signal based on what portion of movie clip is playing on receivers. For example, in case of dialogue conversion in a movie, speech/vocal could be enhanced as compared to music.
6. Adaptive noise cleaning (ANC) in software. ANC needs perfect region of pure noise region where adaptive filter can be trained. Noise vs Audio classifier with high resolution and good boundary decision is crucial for adapting/training the noise cleaning filter such as Weiner filter.
7. Cross-fading application. This application is useful in audio players, where it is desirable to cross fade the tracks. Crossfading is done on part of pure music start and end region where pure music is present between two tracks. Hence, vocal start location detection and vocal end detection in a track is important for cross fading which can be detected using 3 stage classifiers.
8. Aid in vocal removal filters (minus tracks creation). Combining PCA analysis on stereo audio with known vocal regions, better minus track can be created.
9. Adaptive CODEC switching in transmission. Based on speech or music, codec can be made adaptive as speech and music has different compression techniques to achieve high quality compression.
10. Improving compression algorithms and much more. For example, SBR patching and inverse filtering decision can be improved if type of signal is known.

Further advantages of the claimed architecture of the present invention are:
1. Low computation since LSTM prediction is done only once for each time step or frame.
2. Memory reduction. There is no need to store past time steps in LSTM for prediction. States of LSTM layers are already available which were updated in past frame prediction. As a result, substantial amount of memory is saved which is an important aspect of embedded systems.
3. Low delay. There is single audio frame delay in prediction, as soon as frame arrives, LSTM predicts the class and send it out to the system.

The figures and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of the embodiments is by no means limited by these specific examples. Numerous variations, whether explicitly given in the specification or not, such as differences in structure, dimension, and use of material, are possible.

System modules, processes, operations, and algorithms described herein may comprise of hardware, software, firmware, or any combination(s) of hardware, software, firmware suitable for implementing the functionality described herein. Those of ordinary skill in the art will recognize that these modules, processes, operations, and algorithms may be implemented using various types of computing platforms, network devices, Central Processing Units (CPUs), Digital Signal Processors (DSPs), Field Programmable Gate Arrays (FPGAs), operating systems, network devices, or the like. These may also be stored on a tangible medium in a machine-readable series of instructions.

We claim:

1. A method for hierarchical audio classification, said method for hierarchical audio classification comprising:
at least two classification stages;
training and generating at least two independent Long Short-Term Memory (LSTM) neural networks, one for each classification stage, by an audio database tagged into audio classes comprising at least a background noise audio class, and at least a second audio class and at least a third audio class;
training another class transition neural network based on a class transition tagged database;
for each new audio frame input, inputting, into the at least two independent LSTM and the class transition neural network, a plurality of audio frame features;
determining position of a possible audio class transition by using the said class transition neural network over a slice consisting of a plurality of consecutive audio frame features;
classifying the incoming audio signal into either an intelligible audio class or the background noise class at a decision time resolution higher than the slice duration, in a first stage of the at least two stage classifier by using first of the at least two independent LSTM networks configured to run as a stateful predictor;
further classifying the incoming audio signal, upon detecting the intelligible audio class in the first stage of the classifier, into either the second audio class and the third audio at a decision time resolution higher than the slice duration, in a second stage of the at least two stage classifier by using second of the at least two independent LSTM networks configured to run as a stateful predictor; and,
performing a final classification of the incoming audio signal into the at least 3 audio classes at a decision time resolution higher than the slice duration;
wherein the states of stateful LSTM predictors are reset based on class transient location derived using class transition neural network.

2. The method of claim 1, wherein the second audio class is a speech class and the third audio class is a music class.

3. The method of claim 1, wherein audio classified as third audio class is further classified into two separate audio classes resulting in resulting in a 3-stage hierarchical classifier and classification into 4 audio classes.

4. The method of claim 3, where the 4 audio classes are a background noise audio class, a speech audio class, a vocal music audio class, and a non-vocal music audio class.

5. The method of claim 1, wherein the large tagged database is created by assigning, by integer encoding or one-hot encoding, a plurality of labels to a plurality of audio data.

6. The method of claim 1, wherein the plurality of frame features consist of at least 20 features.

7. The method of claim 1 wherein each of the audio frames features is normalized to have mean 0 and standard deviation 1.

8. The method of claim 4, wherein the at least 20 audio frame features inculcate both temporal and frequency domain information.

9. The method as claimed of claim 1, wherein the incoming audio signal is in 44100 Hz sample rate, 16 bit-depth, mono channel PCM WAVE format.

10. The method of claim 1, further comprising removing silence from a clean speech for converting a large duration of silence present in the clean speech to a small duration.

11. The method of claim 1, further comprising low pass filtering with cut-off 2.5 Khz and 4 Khz on a speech sample for audio classification.

12. The method of claim 1, wherein the audio frame slice is 64 frames.

13. The method of claim 10, wherein the desired decision time resolution is once every 16 audio frames.

14. The method of claim 1, wherein the first stage comprises two layers of LSTM having one dense layer and the input to the neural network is audio slice of 64 frames, each having 24 features.

15. The method of claim 1, wherein the input to the neural network in the second stage is audio slice of 64 frames each having 62 features.

16. The method of claim 1, wherein the method uses a two-stage hierarchical binary classifier with two independent Long Short-Term Memory (LSTM) networks.

17. A system for hierarchical audio classification, wherein the said system for hierarchical audio classification comprises:
at least two separate AI models comprising of at least two independent Long Short-Term Memory (LSTM) neural networks for identifying an audio class from a set comprising of at least a background noise class, at least a second audio class and at least a third audio class;
at least another class transition AI neural network for identifying an audio class transition;
inputting, into each neural network, a slice consisting of a plurality of consecutive audio frame features;
at least a first audio classifier for classifying, in a first stage, between an intelligible audio or the background noise, in an incoming audio signal by using first of the at least two independent LSTM networks configured to run as a stateful predictor;
at least a second audio classifier for classifying, in a second stage, between the second audio class or the third audio class, in the incoming audio signal, upon detecting the intelligible audio in the first stage, by using second of the at least two independent LSTM networks configured to run as a stateful predictor; and,
an AI class transition detector for determining position of the audio class transition by running a class transient detection using a transient detector neural network in parallel to each of at least the first stage, and at least the second stage of the hierarchical audio classification;
wherein the states of stateful LSTM predictors are reset based on class transient location derived using class transition detector; and
wherein the system performs a final classification of the incoming audio signal based on the predicted at least 3 audio classes at a decision time resolution higher than the slice duration.

18. A device for hierarchical audio classification, wherein the said device for hierarchical audio classification comprises:
at least two separate AI models comprising of at least two independent Long Short-Term Memory (LSTM) neural networks for identifying an audio class from a set comprising of at least a background noise class, at least a second audio class and at least a third audio class;
at least another class transition AI neural network for identifying an audio class transition;
inputting, into each neural network, a slice consisting of a plurality of consecutive audio frame features at least a first audio classifier for classifying, in a first stage, between an intelligible audio or the background noise, in an incoming audio signal by using first of the at least two independent LSTM networks configured to run as a stateful predictor;
at least a second audio classifier for classifying, in a second stage, between the second audio class or the third audio class, in the incoming audio signal, upon detecting the intelligible audio in the first stage, by using second of the at least two independent LSTM networks configured to run as a stateful predictor; and,
an AI class transition detector for determining position of the audio class transition by running a class transient detection using a transient detector neural network in parallel to each of the at least first stage, and the at least second stage of the hierarchical audio classification;
wherein the states of stateful LSTM predictors are reset based on class transient location derived using class transition detector; and wherein the device performs a final classification of the incoming audio signal based on the predicted at least 3 audio classes at a decision time resolution higher than the slice duration.
